(19) United States
(12) Patent Application Publication
(10) Pub. No.: US 2023/0155308 A1
(43) Pub. Date: May 18, 2023

(54) RELAY CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yuki FUJIMURA, Mie (JP); Hiroshi SHIMIZU, Mie (JP); Hitoshi TAKEDA, Mie (JP); Yusuke ISAJI, Mie (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 17/918,278

(22) PCT Filed: Mar. 30, 2021
(86) PCT No.: PCT/JP2021/013553

§ 371 Date: Oct. 11, 2022

(30) Foreign Application Priority Data
Apr. 27, 2020 (JP) 2020-078213

(51) Int. Cl. H01R 9/24; H01R 9/22; H01R 4/30; H01R 11/09

(52) U.S. Cl. CPC H01R 9/24; H01R 9/223; H01R 4/308; H01R 11/09

(57) ABSTRACT

Provided is a relay connector including a relay terminal including a first connection portion configured to connect to a first device side terminal and a second connection portion configured to connect to a second device side terminal; a clamping member including a first clamping portion configured to clamp the first device side terminal together with the first connection portion and a second clamping portion configured to clamp the second device side terminal together with the second connection portion; a lower case configured to hold the relay terminal; and an upper case configured to hold the clamping member, wherein a connector case includes a first insertion opening and a second insertion opening; and guide portions are formed on the clamping member, the guide portions guiding the first device side terminal inserted from the first insertion opening and the second device side terminal inserted from the second insertion opening.

### TECHNICAL FIELD

The present disclosure relates to a relay connector.

### BACKGROUND ART

A known connection structure for electrically connecting two devices in a vehicle or the like is described in Patent Document 1. In this structure, a first bus bar terminal is installed inside a housing of a bus bar block provided on one side of the device, a second bus bar terminal connected to an electrical wire extending from the other side of the device is inserted from an insertion opening of the housing, and the two are aligned overlapping. The first bus bar terminal and the second bus bar terminal are conductively connected due to a bolt being fastened to a nut overlapped in advance on the opposite surface of the first bus bar in the housing.

### CITATION LIST

### Patent Documents

Patent Document 1: JP 2019-046564A

### Summary of Invention

### Technical Problem

In the known configuration described above, the bolt insertion holes on both bus bars must be accurately positioned and aligned. However, in a case in which the work space is tight, such positioning work is difficult. In particular, in a case in which the diameter of the electrical wire connected to the bus bar is thick, the high stiffness of the electrical wire means that strength is needed to pull and push back the bus bar, making the positioning work even more difficult.

The present disclosure was made in light of the circumstances described above and provides a relay connector that enables work to electrically connect two devices to be easily performed.

### Solution to Problem

A relay connector of the present disclosure includes a first device side terminal and a second device side terminal configured to be electrically connected; a relay terminal with electrical conductivity including a first connection portion configured to connect to the first device side terminal and a second connection portion configured to connect to the second device side terminal; a clamping member disposed facing the relay terminal and including a first clamping portion configured to clamp the first device side terminal together with the first connection portion and a second clamping portion configured to clamp the second device side terminal together with the second connection portion; and a connector case, wherein the connector case includes a first insertion opening for inserting the first device side terminal and a second insertion opening for inserting the second device side terminal; and guide portions are formed on the clamping member, the guide portions guiding the first device side terminal inserted from the first insertion opening between the first clamping portion and the relay terminal and the second device side terminal inserted from the second insertion opening between the second clamping portion and the relay terminal.

### Advantageous Effects of Invention

According to a relay connector of the present disclosure, work to electrically connect two devices can be easily performed.

### BRIEF DESCRIPTION OF DRAWINGS

FIG. 1 is a schematic diagram illustrating a vehicle in which a relay connector of a first embodiment is installed.

FIG. 2 is an exploded perspective view illustrating the relay connector.

FIG. 3 is a perspective view illustrating the relay connector in a connected state.

FIG. 4 is a plan view illustrating the relay connector in a connected state.

FIG. 5 is a perspective view illustrating a virtual partially assembled state for describing the configuration of the relay connector.

FIG. 6 is a plan view illustrating a virtual partially assembled state for describing the configuration of the relay connector.

FIG. 7 is an exploded cross-sectional view illustrating the relay connector taken along cross-section A-A in FIG. 4.

FIG. 8 is a cross-sectional view illustrating the assembly process of the relay connector taken along cross-section A-Ain FIG. 4 (in a state in which a first terminal is attached to a lower case and a second terminal is attached to an upper case).

FIG. 9 is a cross-sectional view illustrating the assembly process of the relay connector taken along cross-section A-A in FIG. 4 (in a state in which the lower case and the upper case are assembled together).

FIG. 10 is a cross-sectional view illustrating the assembly process of the relay connector taken along cross-section A-A in FIG. 4 (in a pre-fastening state in which an external terminal is inserted).

FIG. 11 is a cross-sectional view illustrating the relay connector in a connected state taken along cross-section A-A in FIG. 4 (in a state in which the fastening member is fastened).

FIG. 12 is an enlarged cross-sectional view of an enlarged portion of the region of the locking piece locking structure illustrated in FIG. 9 (in a state before the external terminal is inserted).

FIG. 13 is an enlarged cross-sectional view of an enlarged portion of the region of the locking piece locking structure illustrated in FIG. 10 (in a state after the external terminal is inserted).

FIG. 14 is an enlarged cross-sectional view of a portion of the region of a fastening portion illustrated in FIG. 9.

FIG. 15 is an enlarged cross-sectional view illustrating the process of fastening via a fastening member and a state in which a shaft portion of a bolt is screwed in a nut side fastening hole of a nut after the external terminal is inserted.

FIG. 16 is an enlarged cross-sectional view illustrating the state of FIG. 13 after the bolt is further tighten and a state in which the nut is in contact with the lower surface of the first terminal.

FIG. 17 is an enlarged cross-sectional view illustrating the state of FIG. 14 after the bolt is further tighten and a state in which the upper surface of the nut lifts up from the upper surface of a bottom portion and the first terminal is lifted up toward the second terminal.

FIG. 18 is a cross-sectional view illustrating the assembly process of the relay connector taken along cross-section B-B in FIG. 4 (in a state in which the first terminal is attached to the lower case and the second terminal is attached to the upper case).

FIG. 19 is a cross-sectional view illustrating the assembly process of the relay connector taken along cross-section B-B in FIG. 4 (in a state in which the lower case and the upper case are assembled together).

FIG. 20 is a cross-sectional view illustrating the relay connector in a connected state taken along cross-section B-B in FIG. 4 (in a state in which the fastening member is fastened).

FIG. 21 is a cross-sectional view illustrating the assembly process of the relay connector taken along cross-section C-C in FIG. 4 (in a state in which the first terminal is attached to the lower case and the second terminal is attached to the upper case).

FIG. 22 is a cross-sectional view illustrating the relay connector in a connected state taken along cross-section C-C in FIG. 4.

FIG. 23 is a schematic diagram illustrating the process of installing the relay connector inside a metal housing.

FIG. 24 is a schematic diagram illustrating the process of installing a power storage pack inside the metal housing.

FIG. 25 is a schematic diagram illustrating the process of inserting a power storage pack side terminal into the relay connector.

FIG. 26 is a schematic diagram illustrating the process of bringing a PCU close to the metal housing.

FIG. 27 is a schematic diagram illustrating the process of inserting a PCU side terminal into the relay connector.

FIG. 28 is a schematic diagram illustrating the process of connecting the power storage pack side terminal and the PCU side terminal via fastening with a bolt.

FIG. 29 is a schematic diagram illustrating a state in which the metal housing is closed with a metal cover.

FIG. 30 is a plan view illustrating a relay connector of a second embodiment in a connected state.

FIG. 31 is a cross-sectional view illustrating the relay connector in a connected state.

FIG. 32 is a perspective view illustrating a clamping plate of a third embodiment.

FIG. 33 is a cross-sectional view illustrating the relay connector in a connected state.

FIG. 34 is a plan view illustrating a second terminal of another embodiment.

FIG. 35 is a cross-sectional view illustrating the relay connector in a connected state.

FIG. 36 is a plan view illustrating a second terminal of another embodiment.

FIG. 37 is a cross-sectional view illustrating the relay connector in a connected state

### DESCRIPTION OF EMBODIMENTS

### Description of Embodiments

Firstly, embodiments of the present disclosure will be listed and described.

1. A relay connector of the present disclosure includes a first device side terminal and a second device side terminal configured to be electrically connected; a relay terminal with electrical conductivity including a first connection portion configured to connect to the first device side terminal and a second connection portion configured to connect to the second device side terminal; a clamping member disposed facing the relay terminal and including a first clamping portion configured to clamp the first device side terminal together with the first connection portion and a second clamping portion configured to clamp the second device side terminal together with the second connection portion; and a connector case, wherein the connector case includes a first insertion opening for inserting the first device side terminal and a second insertion opening for inserting the second device side terminal; and guide portions are formed on the clamping member, the guide portions guiding the first device side terminal inserted from the first insertion opening between the first clamping portion and the relay terminal and the second device side terminal inserted from the second insertion opening between the second clamping portion and the relay terminal.

According to the configuration described above, to form an electrical connection, when the first device side terminal and the second device side terminal are inserted between the relay terminal and the clamping member, the distal end portions in the insertion direction of the first device side terminal and the second device side terminal are guided to a regular position by the guide portions provided on the clamping member. Thus, a worker does not need to visually observe the terminals when manually performing the positioning. For example, in cases in which the work space is narrow or the electrical wires connected to the terminals are difficult to manipulate, this allows for the connection work to be easily performed.

2. Preferably, the guide portions are inclined surfaces inclined from the first clamping portion toward the first insertion opening and from the second clamping portion toward the second insertion opening, with an inclination direction of the inclined surfaces being a direction away from the relay terminal.

According to the configuration described above, the clamping member can be easily provided with a guide portion with a simple configuration.

3. Preferably, the connector case includes an assembly of a lower case configured to hold one from among the relay terminal and the clamping member and an upper case configured to hold the other from among the relay terminal and the clamping member.

According to the configuration described above, the relay terminal and the clamping member can be easily attached to the connector case.

4. Preferably, the clamping member is held in the upper case; and locking portions provided on the clamping member lock together with locked portions provided on the upper case, with the first clamping portion and the second clamping portion in a state in which movement is allowed in a direction toward and a direction away from the relay terminal.

According to the configuration described above, the dimension of the gap between the clamping member and the relay terminal is set to be less than the thickness dimension of the first device side terminal and the second device side terminal in a state in which the terminals are not inserted, and when the terminals are inserted, the clamping member is displaced in the direction away from the relay terminal. Then, due to its own weight, the clamping member can come into close contact with the inserted terminals.

5. Preferably, a biasing member configured to urge the clamping member toward the relay terminal is provided on a surface of the clamping member on an opposite side to the relay terminal.

According to the configuration described above, the first device side terminal and the second device side terminal inserted inside the relay connector are pushed toward the relay terminal by the clamping member. This can further improve the electrical connection state.

6. Preferably, a cross-section of the clamping member taken along an alignment direction of the first clamping portion and the second clamping portion is a wave-like shape.

According to the configuration described above also, the first device side terminal and the second device side terminal inserted inside the relay connector are pushed toward the relay terminal by the elastic force of the wave-like shaped clamping member. This can further improve the electrical connection state.

7. Preferably, the clamping member includes an electrical conductive member.

According to the configuration described above, the first device side terminal and the second device side terminal inserted inside the relay connector can be electrically connected by both the clamping member and the relay terminal. This can further improve the electrical connection state.

8. Preferably, the clamping member is made of stainless steel.

According to the configuration described above, the clamping member is made of stainless steel which has high stiffness and resists deformation. Thus, the first device side terminal and the second device side terminal can be more strongly held between the relay terminal and the clamping member with a clamping force.

9. Preferably, the relay terminal and the clamping member are fastened together via a fastening member.

According to the configuration described above, the first device side terminal and the second device side terminal inserted inside the relay connector can be clamped between the relay terminal and the clamping member with a stronger force. This can further improve the electrical connection state.

### DETAILED DESCRIPTION OF EMBODIMENTS

Embodiments of the present disclosure will be described below. Note that the present disclosure is not limited to these examples and is defined by the scope of the claims, and all modifications that are equivalent to or within the scope of the claims are included.

### First Embodiment

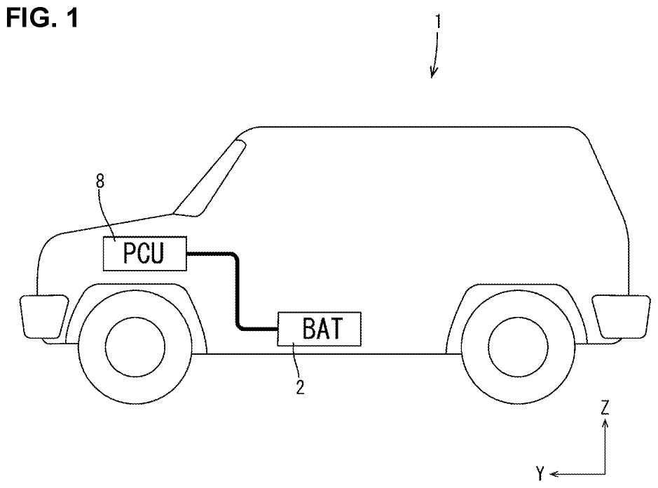

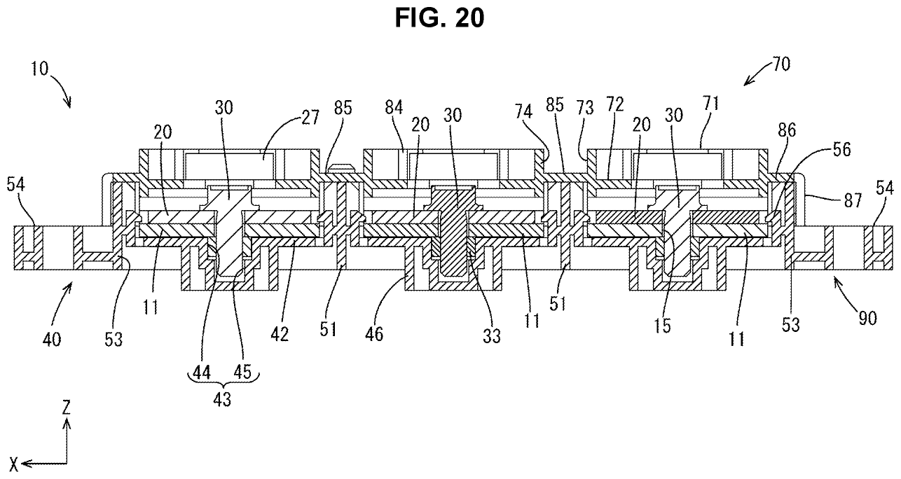

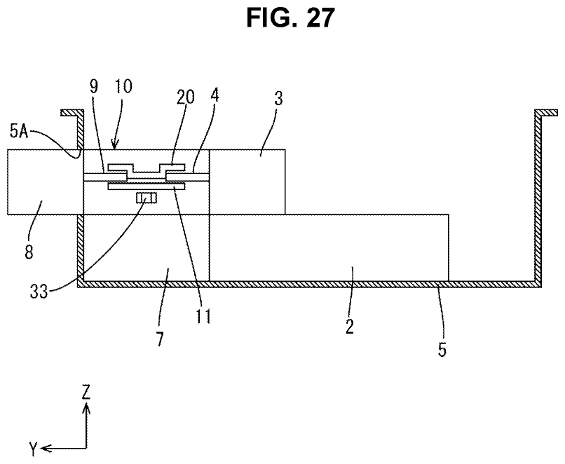

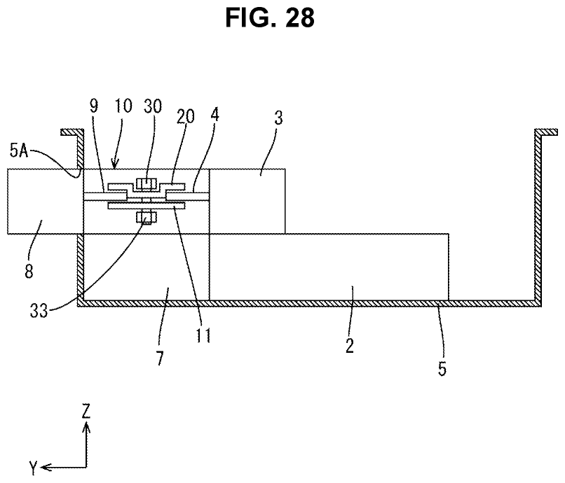

The first embodiment of the present disclosure will now be described with reference to FIGS. 1 to 29. The first embodiment is applied to a relay connector 10 for connecting a power storage pack 2 installed in a vehicle 1, such as an electric vehicle or a hybrid vehicle, and a power control unit (PCU) 8, which is a device located external to the power storage pack 2. Hereinafter, the direction indicated by arrow X is defined as the side direction (right side), the direction indicated by arrow Y is defined as the front direction, and the direction indicated by arrow Z is defined as the up direction. Note that for members including a plurality of members, a reference sign or number may only be given to one or more of the members of the plurality and not given to other members.

The power storage pack 2 (an example of a first device) is used as a power supply for driving the vehicle 1 and is installed in the central region of the vehicle 1 as illustrated in FIG. 1. The PCU 8 (an example of a second device) is installed in the front portion of the vehicle 1. The power storage pack 2 and the PCU 8 are connected by the relay connector 10.

Though not illustrated in detail, the power storage pack 2 includes a plurality of power storage modules each including a plurality of power storage elements connected in series, with the power storage modules being fixed to a base plate via an insulating protector. The power storage element may be nickel-hydrogen rechargeable battery, a lithium ion rechargeable battery, or other similar rechargeable battery or a capacitor. In the present embodiment, the power storage element is a lithium ion battery.

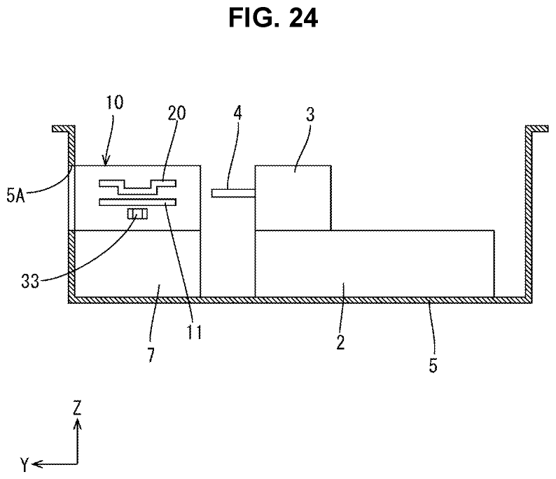

Protective members, including a relay, a current detector, a fuse, and the like, are connected to the power storage pack 2. As illustrated in FIG. 24, these protective members are housed inside a junction box 3 installed on the front end of the upper surface of the power storage pack 2. A plurality (three in the present embodiment) of power storage pack side terminals 4, each with a tab-like shape for connecting to the PCU 8 via the relay connector 10, are arranged side by side in the lateral direction (X-direction) projecting forward from the junction box 3, with the plate surface facing the up-and-down direction (Z-direction).

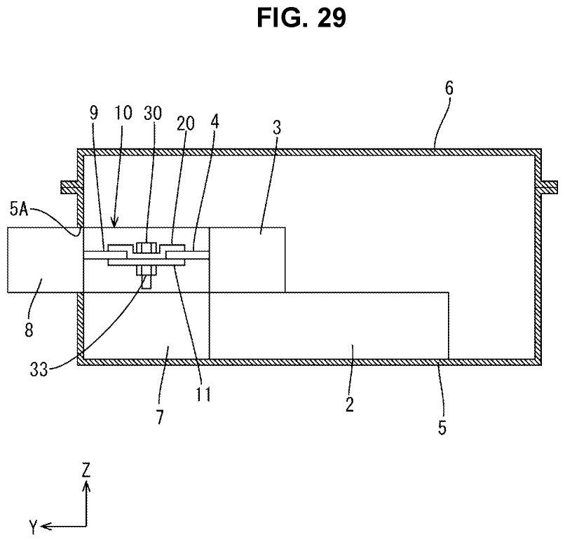

The power storage pack 2 and the junction box 3 are housed in a metal housing 5. The metal housing 5 has a box-like shape with the upper surface opened. The opening is closed by a metal cover 6 (see FIG. 29).

A connector platform 7 where the relay connector 10 is placed is provided on the front side inside the metal housing 5. Also, in a case in which the relay connector 10 is installed at a regular position and at a regular orientation on the connector platform 7, a case side insertion opening 5A communicating with a second insertion opening 92 of the relay connector 10 described below is formed at a position corresponding to the second insertion opening 92 in the front wall of the metal housing 5.

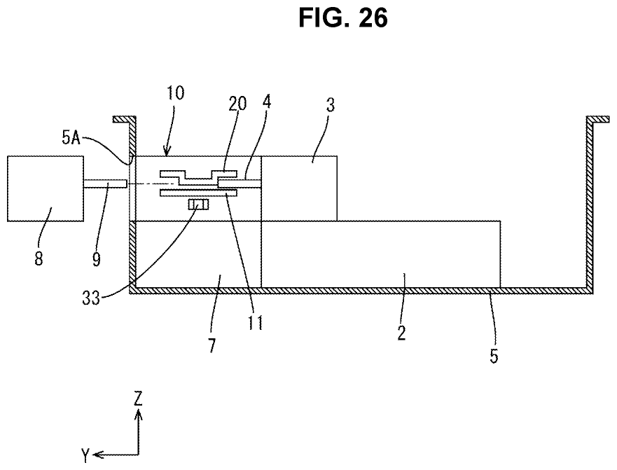

Also, as illustrated in FIG. 26, a plurality (three in the present embodiment) of PCU side terminals 9, each with a tab-like shape for connecting to the power storage pack 2 via the relay connector 10, are arranged side by side in the lateral direction (X-direction) projecting backward from the PCU 8, with the plate surface facing the up-and-down direction (Z-direction). The width dimension and the thickness dimension of the PCU side terminals 9 are equal to the width dimension and the thickness dimension of the power storage pack side terminals 4.

### Relay Connector 10

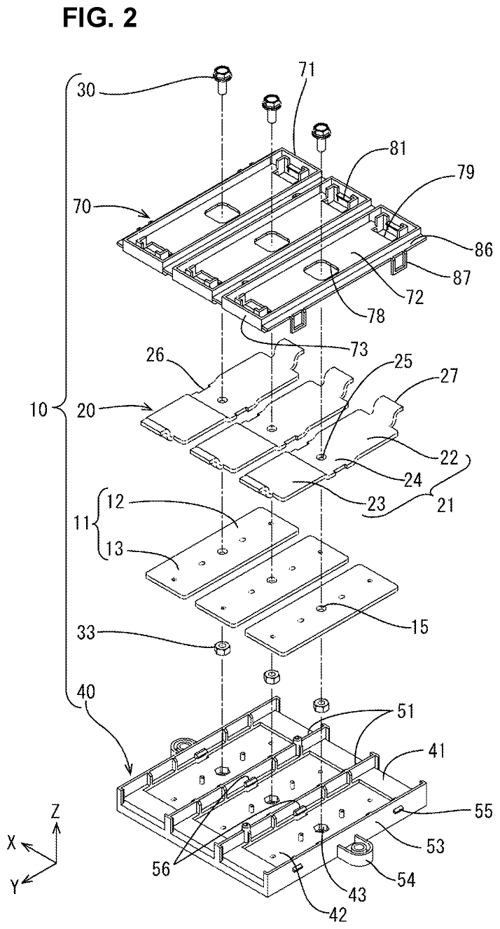

As illustrated in FIG. 2, the relay connector 10 is provided with a first terminal 11 (an example of a relay terminal), a second terminal 20 (an example of a clamping member), a lower case 40 for holding the first terminal 11 in position, an upper case 70 for holding the second terminal 20 in position, and fastening members (bolt 30 and nut 33) for fastening the first terminal 11 and the second terminal 20. In the description below, the first terminal 11 and the second terminal 20 are disposed with their longitudinal direction aligned with the front-and-back direction (Y-direction).

### First Terminal 11

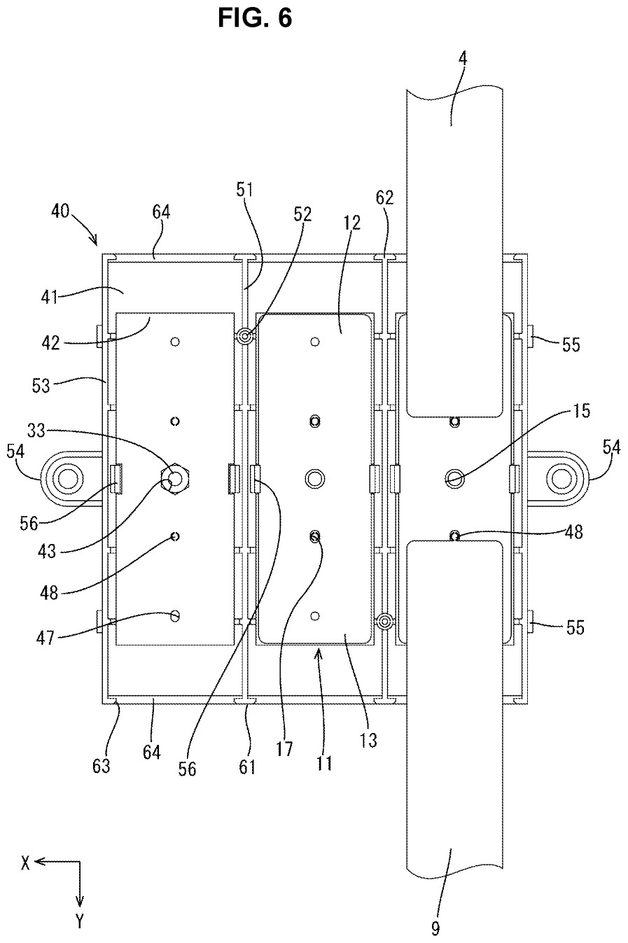

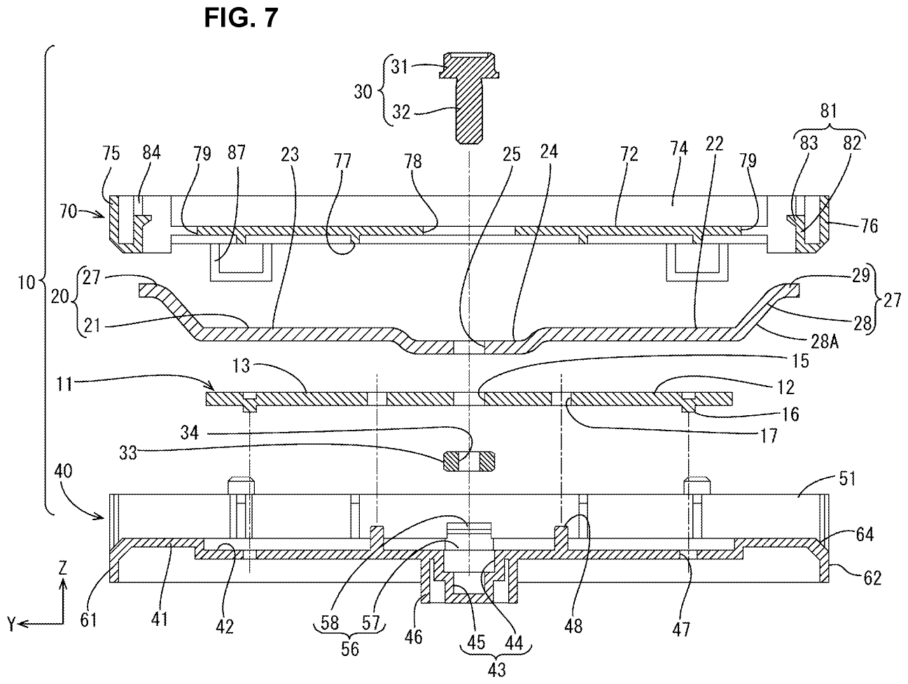

The first terminal 11 is made of a rectangular copper plate with one end side (back side) in the longitudinal direction corresponding to a first connection portion 12 conductively connected to the power storage pack side terminal 4 described above and the other end side (front side) corresponding to a second connection portion 13 conductively connected to the PCU side terminal 9 described above. In a central region of the first terminal 11, a first terminal side fastening hole 15 is provided extending through the plate surface. A shaft portion 32 of the bolt 30 is inserted into the first terminal side fastening hole 15 to fasten the first terminal 11 to the second terminal 20. Also, as illustrated in FIG. 7, a pair of first terminal side protrusion portions 16 projecting downward for positioning the first terminal 11 in the lower case 40 are press-formed near the end portions on both sides in the longitudinal direction. Furthermore, between each first terminal side protrusion portion 16 and the first terminal side fastening hole 15, a first terminal side hole portion 17 where a lower case side protrusion portion 48 provided on the lower case 40 side is inserted is provided extending through the plate surface. The first terminal side hole portions 17 have an elongated shape elongated in the longitudinal direction (see FIG. 6).

The width dimension (dimension in the X-axis direction) of the first terminals 11 is greater than the width dimension of the power storage pack side terminals 4 and the PCU side terminals 9.

### Second Terminal 20

The second terminal 20 is made of a copper plate in a similar manner to the first terminal 11 and is provided with a rectangular body portion 21 disposed above the first terminal 11 and a pair of locking pieces 27 disposed extending from both end edges in the longitudinal direction of the body portion 21. The end on one side (back side) in the longitudinal direction of the body portion 21 corresponds to a first clamping portion 22 for clamping the power storage pack side terminals 4 with the first connection portion 12 of the first terminal 11, and the end on the other side (front side) corresponds to a second clamping portion 23 for clamping the PCU side terminals 9 with the second connection portion 13 of the first terminal 11. Note that the width dimension of the body portion 21 is the same as the width dimension of the first terminal 11.

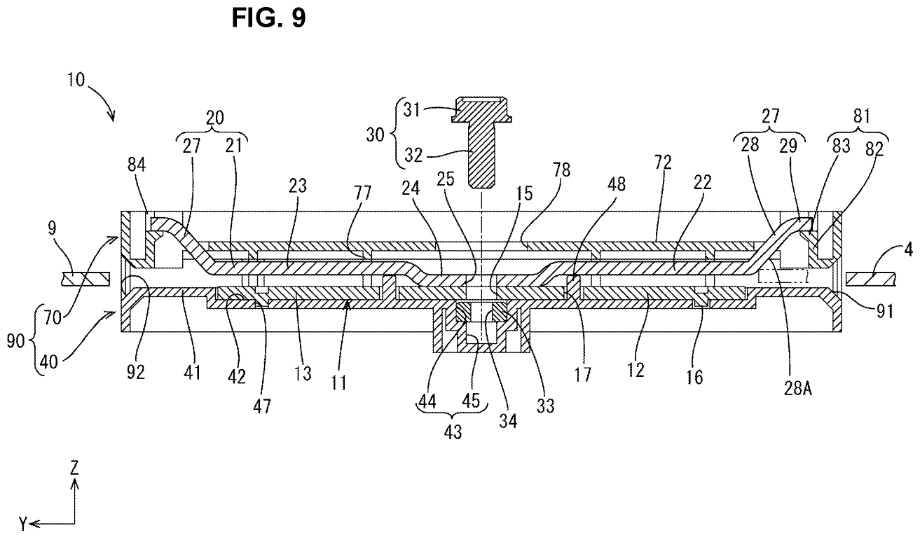

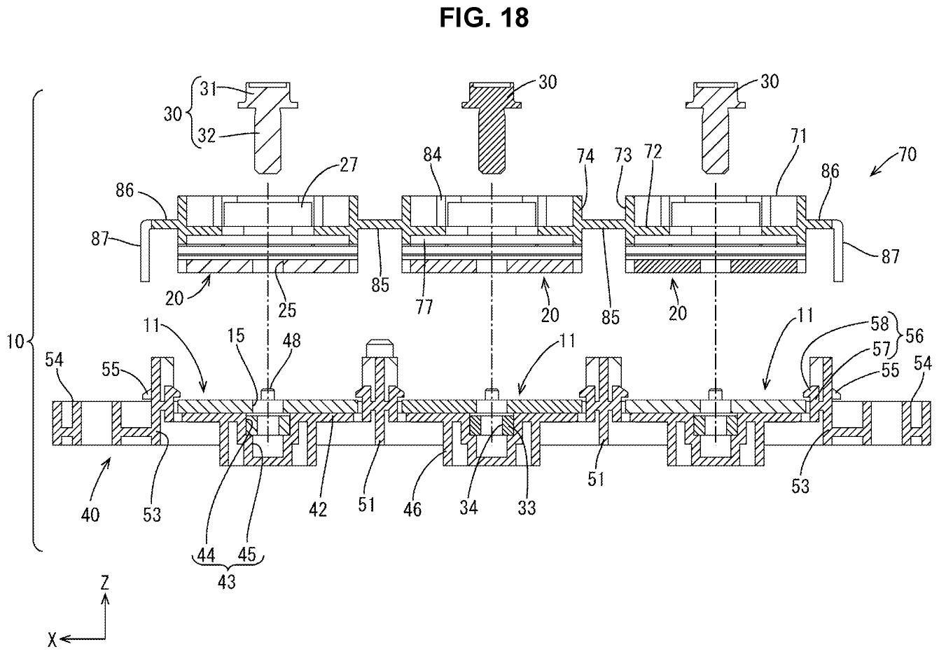

A central portion in the longitudinal direction of the body portion 21 corresponds to a recess portion 24 which is recessed downward (toward the first terminal 11) across the entire width direction (X-direction), and, in the central region of the recess portion 24, a second terminal side fastening hole 25 is provided extending through the plate surface. The shaft portion 32 of the bolt 30 is inserted into the second terminal side fastening hole 25 to fasten the second terminal 20 to the first terminal 11. The length dimension (dimension in the Y-axis direction) of the recess portion 24 in the longitudinal direction of the body portion 21 is less than the length dimension between the pair of first terminal side hole portions 17 of the first terminal 11 described above. In other words, the recess portion 24 has a length dimension such that it fits in the space between the pair of first terminal side hole portions 17 (see FIG. 9). Also, the depth dimension of the recess portion 24 is equal to or less than the thickness dimension of the power storage pack side terminals 4 and the PCU side terminals 9. Note that a pair of cutout portions 26 are formed (see FIGS. 2 and 18) in the pair of side edge portions (edge portions in the Y-direction) of the recess portion 24. Terminal locking catches 56 of the lower case 40 described below are fit into the pair of cutout portions 26.

As illustrated in FIG. 7, the pair of locking pieces 27 have a cantilever shape that bends like a crank extending upward (in the Z-direction or direction away from the first terminal 11) and outward from both end edges in the longitudinal direction of the body portion 21. The base end side of each one of the pair of locking pieces 27 correspond to a guide portion 28 extending at an incline upward from the body portion 21 and the lower surface thereof (the surface on the first terminal 11 side) corresponds to a guiding surface 28A with an inclined shape that guides the power storage pack side terminals 4 and the PCU side terminals 9 described above between the first terminal 11 and the body portion 21 of the second terminal 20. Also, the distal end side corresponds to a locking portion 29 for locking together with the upper case 70 described below that extends outward and parallel with the body portion 21.

Note that the metal constituting the first terminal 11 and the second terminal 20 is not particularly limited, and a discretionary metal can be selected as appropriate with examples including not only copper but a copper alloy, aluminum, an aluminum alloy, stainless steel (SUS), nickel, a nickel alloy, and the like. The surface of the first terminal 11 and the second terminal 20 may be plated with a metal other than the metal constituting the terminals. The metal used to plate the surface of the terminals can be a discretionary metal selected as appropriate with examples including tin, solder, nickel, and the like. Also, the first terminal 11 and the second terminal 20 may be formed of a similar type of metal or may be formed of different types of metal.

### Lower Case 40

The lower case 40 is made of a synthetic resin (with insulating properties) and is provided with a bottom wall 41 that covers the first terminals 11 described above from the bottom and the sides (left-and-right direction, X-direction) and has an overall rectangular plate-like shape elongated in the front-and-back direction (Y-direction). The bottom wall 41 is disposed with the pair of side edge portions aligned with the front-and-back direction. The length dimension in the front-and-back direction of the bottom wall 41 is configured to be a dimension that allows the second terminal 20 held by the upper case 70 to be internally housed when the upper case 70 described below and the lower case 40 are in an assembled state.

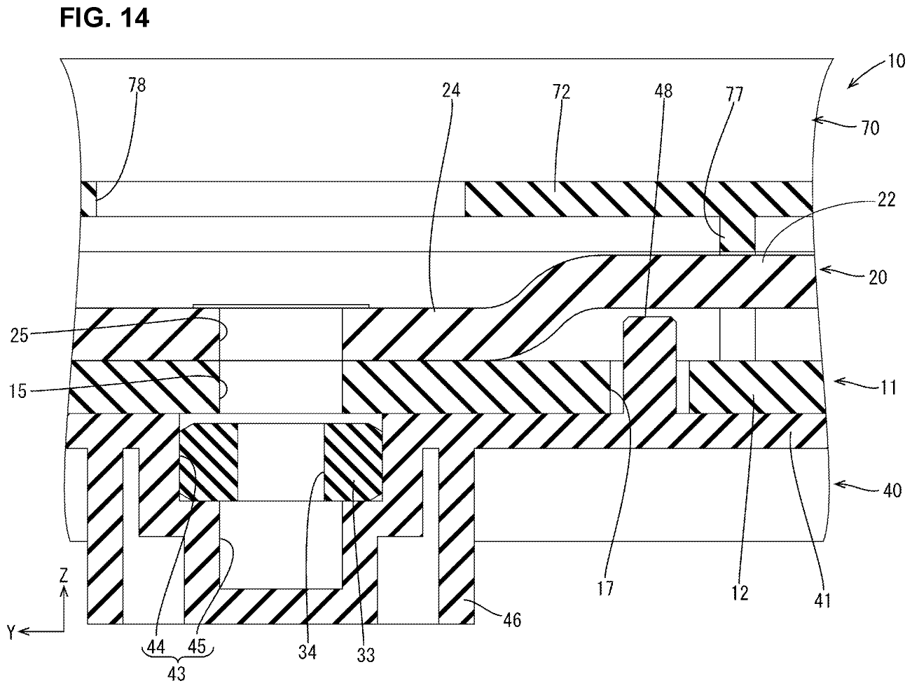

Three positioning recess portions 42 for housing the first terminals 11 are provided side by side in the upper surface of the bottom wall 41. The depth of the positioning recess portions 42 is configured to be the same as the plate thickness of the first terminals 11. A housing recess portion 43 that projects toward the lower surface and houses the nut 33, i.e., the fastening member, is formed in a central region of each of the positioning recess portions 42. As illustrated in FIG. 7, the housing recess portion 43 has a two level structure including a nut housing portion 44 recessed downward from the upper surface of the positioning recess portion 42 and a relief portion 45 recessed from the nut housing portion 44 downward. The nut housing portion 44 is a hexagon in a plan view, and the hexagon nut 33 is fitted into the inside of the nut housing portion 44 with the hexagon nut 33 in a state of being fixed in the rotation direction but allowed to move in the up-and-down direction (Z-direction). The nut housing portion 44 is configured so that, in a state in which the nut 33 is fitted inside the nut housing portion 44, it has a depth so that the upper surface of the nut 33 is flush with the upper surface of the positioning recess portions 42 or the upper surface is at a position lower than the upper surface of the positioning recess portions 42 (see FIG. 14). The relief portion 45 has a smaller inner diameter than the nut housing portion 44 and allows space for the shaft portion 32 of the bolt 30 screwed into the nut 33. Note that a frame-like protective wall 46 is provided on the lower surface of the bottom wall 41 surrounding the outer circumference of the housing recess portion 43.

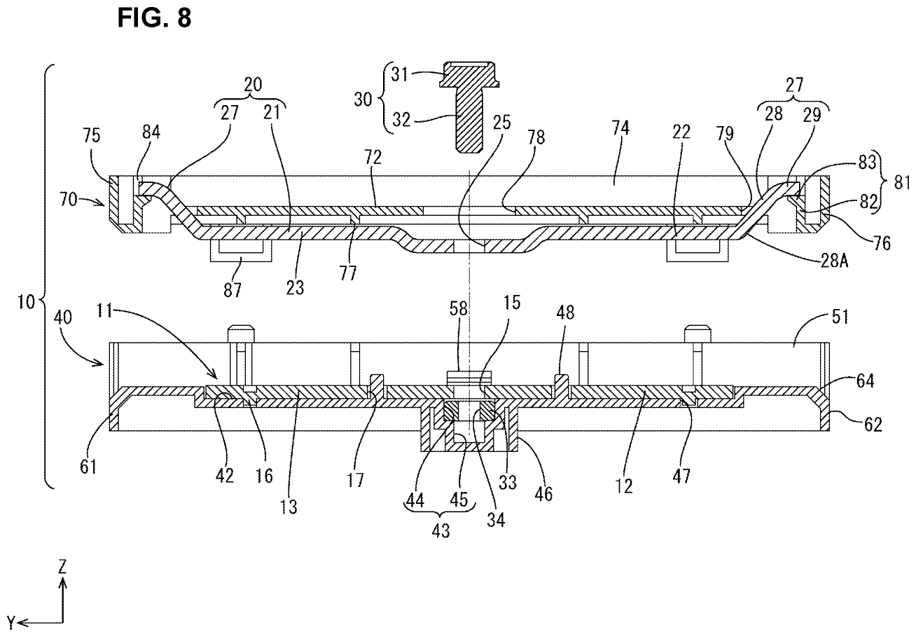

As illustrated in FIG. 7, lower case side hole portions 47 into which the first terminal side protrusion portions 16 fit when the first terminals 11 are housed are provided at positions in the positioning recess portions 42 corresponding to the first terminal side protrusion portions 16. Also, the lower case side protrusion portions 48 are provided at positions corresponding to the first terminal side hole portions 17 when the first terminals 11 are housed. The first terminals 11 are housed in the positioning recess portions 42, the first terminal side protrusion portions 16 are fit into the lower case side hole portions 47, and the lower case side protrusion portions 48 are fit into the first terminal side hole portions 17. Thus, the first terminals 11 are positioned with respect to the lower case 40 in a fixed state in the direction (X-Y direction) along the upper surface of the bottom wall 41 (see FIG. 8). Also, because the pair of side edge portions of the first terminals 11 are locked together with the pair of terminal locking catches 56 of the lower case 40 described below, the first terminals 11 are restricted from moving upward beyond catch portions 58 of the terminal locking catches 56 described below (see FIG. 18).

Note that the dimension of the lower case side protrusion portion 48 rising upward from the housing recess portion 43 is greater than the thickness dimension of the first terminal 11, and when the first terminal 11 is housed in the housing recess portion 43, the lower case side protrusion portions 48 project upward from the upper surface of the first terminal 11 (see FIG. 8).

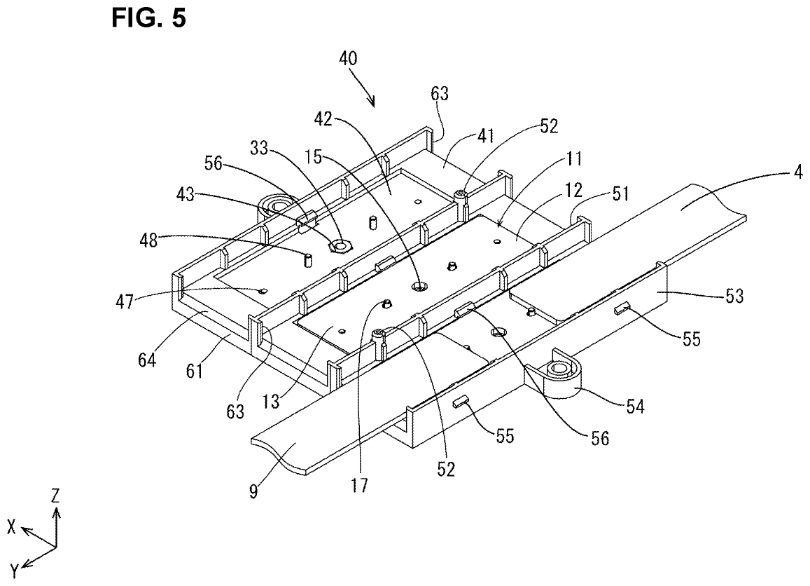

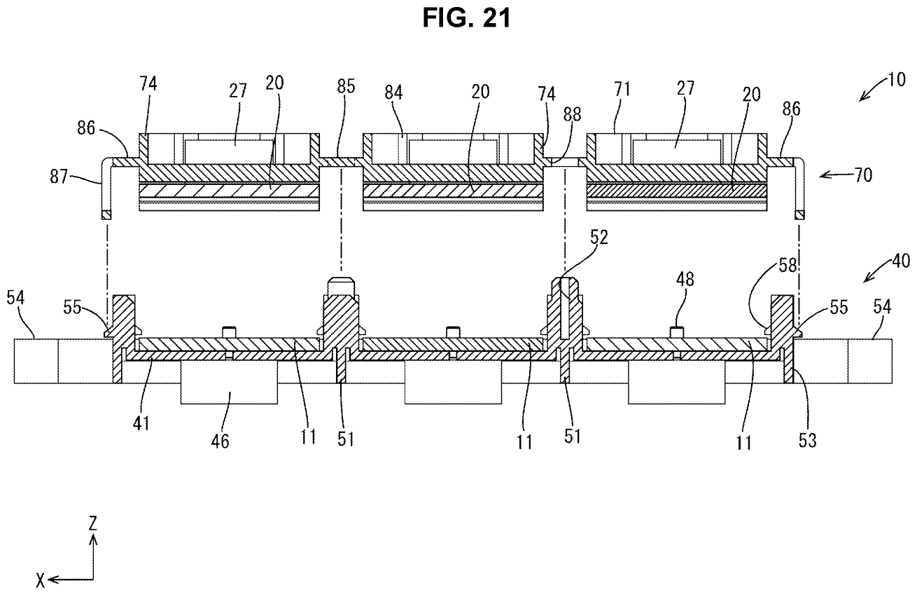

As illustrated in FIGS. 5, 18, 21, the adjacent positioning recess portions 42 are divided by a pair of partition walls 51 that extend in the front-and-back direction (Y-direction) and projects out from the upper surface and the lower surface of the bottom wall 41. These partition walls 51 keep the adjacent first terminals 11 and the terminals connected to the first terminals 11 insulated. Also, as illustrated in FIGS. 5 and 21, the pair of partition walls 51 are each provided with a lower case side positioning hole 52 located at near the end portion on opposite sides in the front-and-back direction. The lower case side positioning holes 52 are for positioning the partition walls 51 and connection walls 85 of the upper case 70 described below.

As illustrated in FIGS. 5, 18, and 21, the bottom wall 41, at the pair of side edge portions extending in the front-and-back direction, is provided with side walls 53 projecting both upward and downward from the bottom wall 41. The dimensions of the partition walls 51 and the side walls 53 projecting from the bottom wall 41 are the same on the upper surface side and the bottom surface side. In other words, the partition walls 51 and the side walls 53 are set to dimensions so that the upper end surfaces and the lower end surfaces come to the same position.

The pair of side walls 53 are provided with a pair of attachment portions 54 jutting outward (X-direction) from the lower end centrally located in the front-and-back direction. The attachment portions 54 are for fixing the lower case 40 (relay connector 10) to the connector platform 7. Also, the pair of side walls 53 are provided with claw-like lower case side locking portions 55 located to the front and the back of the attachment portions 54. The lower case side locking portions 55 are for locking together the upper case 70 and the lower case 40. The pair of side walls 53 are provided with a total of four lower case side locking portions 55.

The bottom wall 41 is provided with a total of six terminal locking catches 56 located centrally in the front-and-back direction (see FIGS. 5 and 6). As illustrated in FIG. 18, the terminal locking catches 56 are provided adjacent to the positioning recess portions 42 and each have a roughly L-shape including the catch portion 58 extending toward the positioning recess portions 42 formed at the distal end of an elastically deforming portion 57 projecting upward from the bottom wall 41. The lower surfaces of the catch portions 58 are set to a position above the upper surfaces of the first terminals 11 when the first terminals 11 are housed in the positioning recess portions 42. In other words, the first terminals 11 are in a state in which up and down movement below the catch portions 58 is allowed but movement upward above the catch portions 58 is restricted by the terminal locking catches 56.

As illustrated in FIGS. 5 and 7, the front end edge of the bottom wall 41 is provided with a front wall 61 projecting both upward and downward from the bottom wall 41. Also, in a similar manner, the back end edge of the bottom wall 41 is provided with a back wall 62 projecting both upward and downward from the bottom wall 41. The dimensions of the front wall 61 and the back wall 62 projecting from the bottom wall 41 are the same on the upper surface side and the bottom surface side as the dimensions of the partition walls 51 and the side walls 53 projecting from the bottom wall 41. In other words, the front wall 61, the back wall 62, the partition walls 51, and the side walls 53 are set to dimensions so that the upper end surfaces and the lower end surfaces come to the same position (see FIG. 7).

As illustrated in FIG. 5, the front wall 61 and the back wall 62 are each provided with three recessed opening portions 63 for exposing the upper surface of the bottom wall 41 to the outside when the upper case 70 and the lower case 40 are in an assembled state. Specifically, the recessed opening portions 63 are formed as cutouts from the upper end of the front wall 61 and the back wall 62 recessed downward and are formed with the center line in the width direction (X-direction) aligned with the center line in the width direction of the positioning recess portions 42. Also, the cutout depth from the upper end is the same as the height dimension from the upper end to the bottom wall 41, and the width dimension is greater than the width dimension of the power storage pack side terminals 4 and the PCU side terminals 9.

Note that the end edge portion (corner portion of the front end and back end) of the recessed opening portion 63 that is continuous with the upper surface of the bottom wall 41 corresponds to an inclined surface 64 cutout at a downward incline.

### Upper Case 70

The upper case 70 is made of the same synthetic resin as the lower case 40, covers and holds the three second terminals 20 described above from above, closes the upper side opening of the lower case 40, and has an overall rectangular shape elongated in the front-and-back direction (Y-direction). Specifically, the upper case 70 includes three holding portions 71 that hold the second terminals 20 connected by the connection walls 85.

The holding portions 71 are each provided with an elongated rectangular ceiling wall 72 that covers the second terminal 20 from above and a peripheral wall 73 that extends upward and downward from the peripheral portion of the ceiling wall 72. Hereinafter, the pair of portions of the peripheral wall 73 extending in the longitudinal direction (Y-direction) are referred to as side wall portions 74 and the portion extending in the width direction (X-direction) on the front side is referred to as a front wall portion 75 and on the back is referred to as a back wall portion 76.

The length dimension (Y-direction dimension) of the side wall portions 74 of the peripheral wall 73 is greater than the length dimension of the second terminal 20, and the length dimension (X-direction dimension) of the front wall 61 and the back wall 62 is similar to the dimension in the width direction of the body portion 21 of the second terminal 20. Also, the lower surface of the ceiling wall 72 is provided with four ribs 77 that bridge between the pair of side wall portions 74 (see FIG. 7). The height dimension of the ribs 77 from the ceiling wall 72 is similar to the height dimension of the portion of pair of side wall portions 74 projecting toward the lower surface from the ceiling wall 72. In other words, the upper surfaces of the body portions 21 of the second terminals 20 are abuttable with both the lower end surfaces of the pair of side wall portions 74 and the lower end surfaces of the four ribs 77 (see FIG. 8).

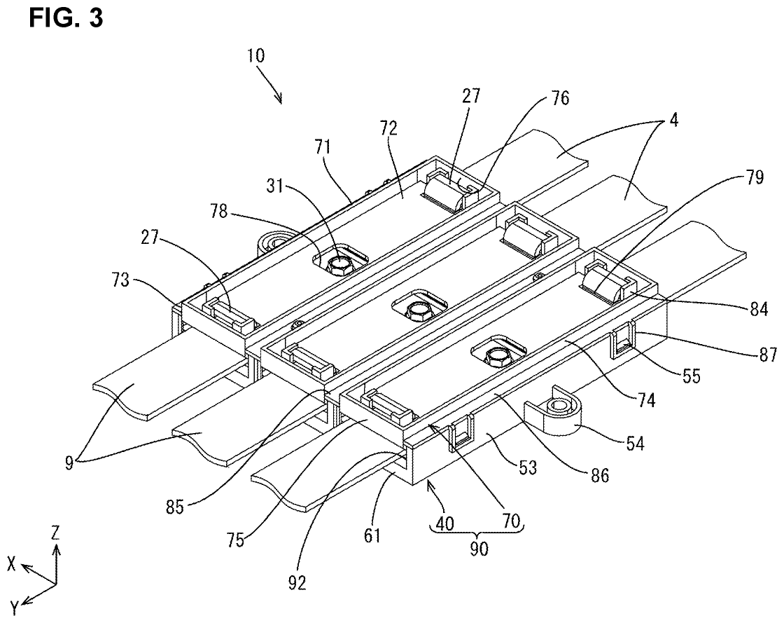

As illustrated in FIGS. 3 and 7, a rectangular hole portion 78 for fastening together the first terminal 11 and the second terminal 20 with a bolt is provided centrally in the ceiling wall 72. The inner diameter of the hole portion 78 is configured to be greater than the outer diameter of a head portion 31 of the bolt 30. Also, the ceiling wall 72 is provided with a pair of rectangular locking piece insertion holes 79 near both end portions in the longitudinal direction. The pair of locking piece insertion holes 79 are where the pair of locking pieces 27 of the second terminal 20 described above are inserted. The width dimension of the locking piece insertion holes 79 is set to be slightly greater than the width dimension of the locking pieces 27 of the second terminal 20. Also, flexible locking pieces 81 for locking in the locking pieces 27 of the second terminal 20 inserted into the locking piece insertion holes 79 are provided at a portion of the hole edge portion of the locking piece insertion holes 79 adjacent to the front end and the back end of the ceiling wall 72.

As illustrated in FIG. 7, the flexible locking pieces 81 each includes an elastically deforming portion 82 projecting inward from the lower end of the front wall portion 75 or the back wall portion 76 and forming a U-shape and a catch portion 83 located at the upper end of the elastically deforming portion 82 that projecting toward the locking piece insertion hole 79. The catch portion 83 includes lower surface side with inclined surface shape that is inclined upward and toward the locking piece insertion hole 79 and an upper surface that is a flat surface parallel with the ceiling wall 72. The upper surface of the catch portion 83 is located above the upper surface of the ceiling wall 72.

The flexible locking piece 81 extends in the up-and-down direction from a portion of the hold edge portion of the locking piece insertion hole 79 adjacent to the front end and the back end of the ceiling wall 72. Also, the flexible locking piece 81 is formed with a cutout portion of a locking piece positioning portion 84 with a wall-like shape surrounding the locking piece insertion hole 79 in a C shape. The upper end surface of the locking piece positioning portion 84 is flush with the upper end surface of the peripheral wall 73. Note that the upper surface of the catch portion 83 of the flexible locking piece 81 described above is set to a height such that the upper surface of the locking piece 27 is positioned at the same position or below the peripheral wall 73 and the upper end surface of the locking piece positioning portion 84 when the locking piece 27 is in a state of being locked together with the upper surface of the catch portion 83.

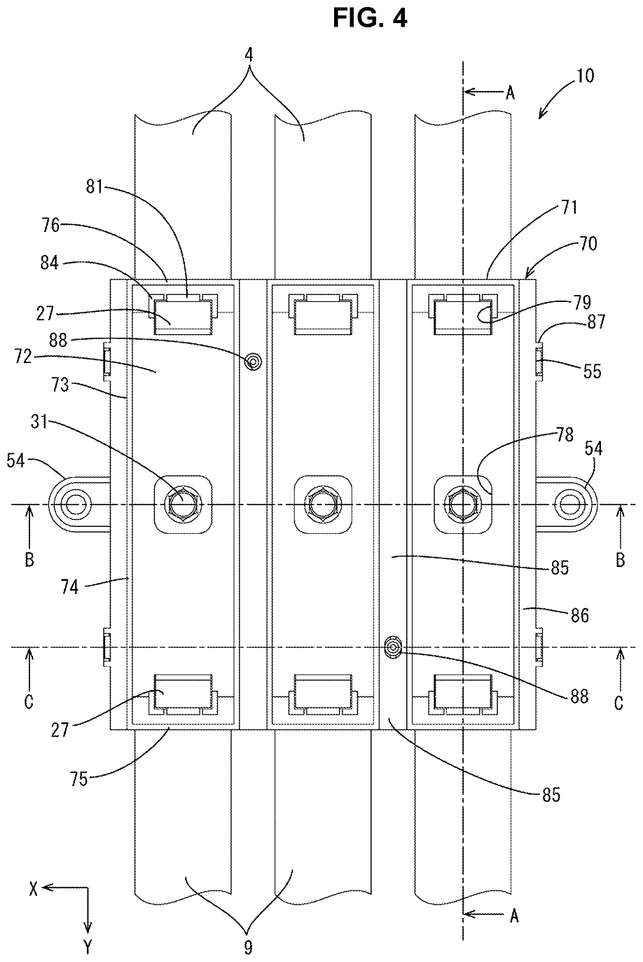

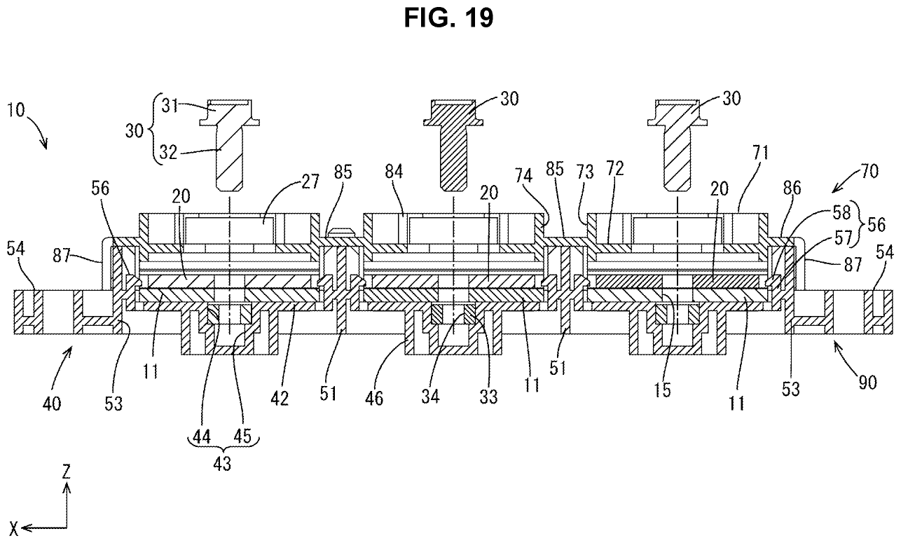

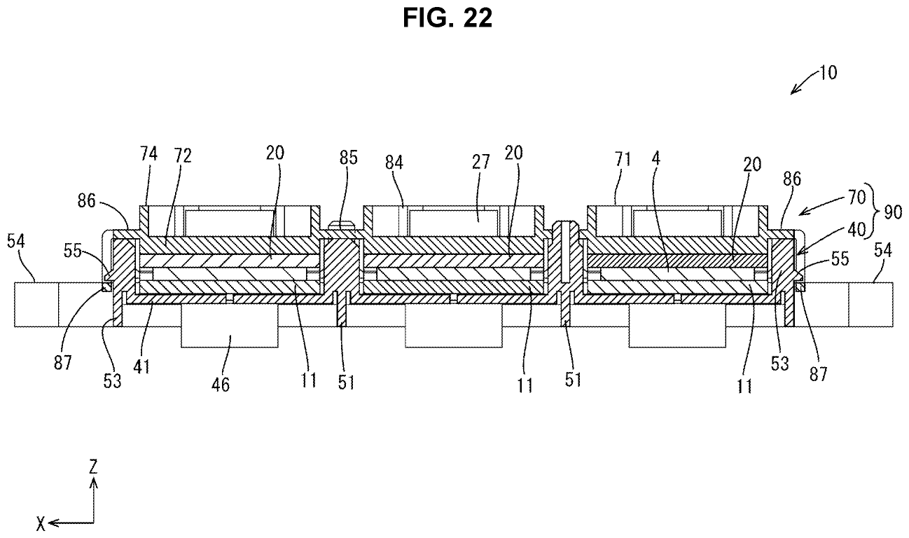

As illustrated in FIGS. 4, 18, and 21, the upper case 70 includes the three holding portions 71 described above disposed side by side in the lateral direction (X-direction), with the side wall portions 74 of the adjacent holding portions 71 connected together via the plate-like connection walls 85 extending in the front-and-back direction. Also, the pair of side wall portions 74 located on both ends in the width direction (X-direction) are each provided with an auxiliary wall 86 at the same height position as the connection walls 85. The auxiliary walls 86 each extend in the front-and-back direction and outward. The auxiliary walls 86 come into contact with the upper end surface of the side walls 53 of the lower case 40 and support the upper case 70 when the upper case 70 and the lower case 40 are assembled together (see FIGS. 19 and 22). Also, the auxiliary walls 86 are provided with a total of four upper case side locking pieces 87 for locking together with the lower case side locking portions 55 of the lower case 40 described above (see FIG. 2). The upper case side locking pieces are located at a position on the auxiliary walls corresponding to the lower case side locking portions 55 and extend downward forming a U shape.

Also, as illustrated in FIG. 4, the pair of connection walls 85 are each provided with an upper case side positioning hole 88 located at near the end portion on opposite sides in the front-and-back direction. The upper case side positioning holes 88 are for positioning the connection walls 85 and the partition walls 51 of the lower case 40. The upper case side positioning holes 88 are provided at positions corresponding to the lower case side positioning hole 52 described above when the upper case 70 and the lower case 40 are in an assembled state and fastened together via bolts. Note that the upper case side positioning hole 88 located on the front side is an elongated hole elongated in the front-and-back direction.

### Relay Connector 10 Assembly Process

Next, the assembly process of the relay connector 10 will be described. When assembling the relay connector 10 of the present embodiment, first, the nuts 33 are housed in the lower case 40, and then the first terminals 11 are attached (see FIGS. 8, 18, and 21). Specifically, the nuts 33 are fit inside the nut housing portions 44 of the lower case 40, and then the first terminals 11 are housed from above into the positioning recess portions 42. When the first terminals 11 are brought close to the positioning recess portions 42, the lower surfaces of the first terminals 11 come into contact with the upper surfaces of the catch portions 58 of the pair of terminal locking catches 56, and when the first terminals 11 are pushed down, the elastically deforming portions 57 deform outward. Then, when the first terminals 11 pass the inner end portions of the catch portions 58, the elastically deforming portions 57 elastically return, and the lower surfaces of the catch portions 58 and the upper surfaces of the first terminals 11 face one another. Also, the lower case side protrusion portions 48 of the lower case 40 are inserted into the first terminal side hole portions 17, and the first terminal side protrusion portions 16 of the first terminals 11 are fit inside the lower case side hole portions 47 of the lower case 40. At this time, the first terminal side hole portions 17 have an elongated hole shape elongated in the front-and-back direction, allowing tolerance to be absorbed when inserting the lower case side protrusion portions 48.

In this manner, the first terminals 11 are positioned in the lower case 40 in a state in which movement is not allowed in the direction along the bottom wall 41 (X-Y direction) and movement slightly in the up-and-down direction (Z-direction) is allowed. Note that in this state, the first terminal side fastening holes 15 of the first terminals 11 are disposed overlapping nut side fastening holes 34 of the nuts 33 in the up-and-down direction (Z-direction).

Next, the second terminals 20 are attached to the upper case 70. Specifically, the pairs of locking pieces 27 of the second terminals 20 are positioned to overlap the pairs of locking piece insertion holes 79 from the back surface (lower surface in FIG. 7) of the upper case 70, and the second terminals 20 are pushed toward the upper case 70. In this manner, the distal ends (locking portions 29) of the locking pieces 27 come into contact with the catch portions 83 of the flexible locking pieces 81 of the upper case 70 and press against the inclined lower surfaces of the catch portions 83, making the elastically deforming portions 82 gradually elastically deform outward. Then, when the distal ends of the locking pieces 27 pass the distal ends of the catch portions 83, the elastically deforming portions 82 elastically return, and the locking portions 29 of the locking pieces 27 lock together with the upper surfaces of the catch portions 83. In this manner, after the distal ends of the locking pieces 27 pass the distal ends of the catch portions 83, pressing force is no longer required. Thus, a worker can confirm that the second terminals 20 are locked in the upper case 70. Accordingly, the second terminals 20 are put in a state of being held by the upper case 70.

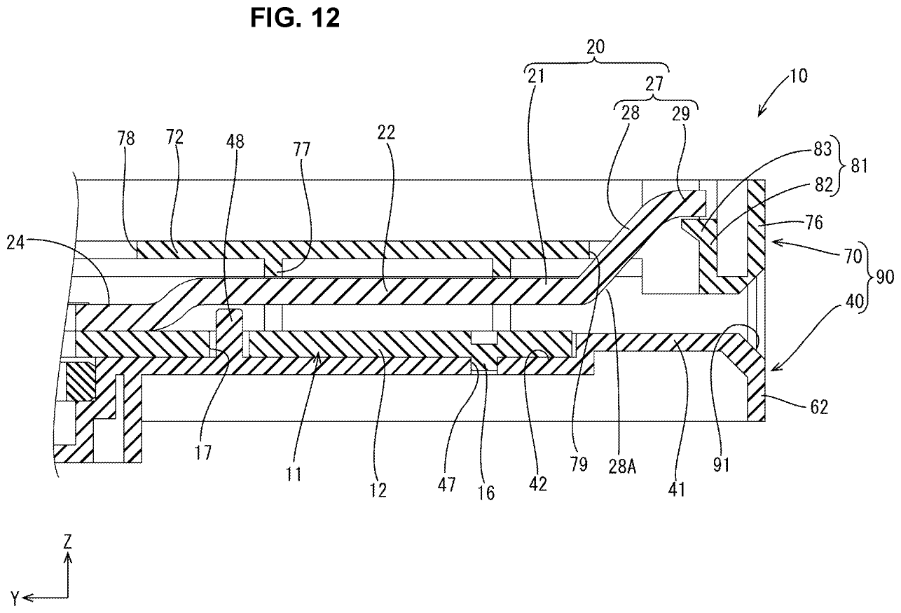

Note that in this state, the second terminals 20 are held in the upper case 70 in a state in which movement is allowed in the direction toward and away from the upper case 70 (up-and-down direction, Z-direction) (see FIG. 12). In other words, in a state in which the lower surfaces of the locking pieces 27 of the second terminals 20 are in contact with the upper surfaces of the catch portions 83, gaps are formed between the lower surfaces of the ribs 77 provided on the lower surface of the lower case 40 and the upper surfaces of the second terminals 20.

Next, the upper case 70 is attached to the lower case 40 (see FIGS. 9 and 19). Specifically, the second terminals 20 and the first terminals 11 are brought to face one another by bringing the upper case 70 close to the lower case 40 and bringing the pairs of the upper case side locking pieces 87 into contact with the pairs of the lower case side locking portions 55. Then, when the upper case 70 is pushed downward, the upper case side locking pieces 87 elastically deform outward along the upper surfaces of the lower case side locking portions 55 and, after passing the lower case side locking portions 55, elastically return and lock together with the lower case side locking portions 55. In this manner, a connector case 90 including the assembled upper case 70 and the lower case 40 is formed (see FIG. 3).

Accordingly, the relay connector 10 is assembled (however in this state, the bolts 30 are not fastened). As illustrated in FIG. 9, in this assembled state, the second insertion openings 92 defined by the front walls 61 of the lower case 40 opening in a recessed shape and the front wall portions 75 of the upper case 70 are formed on the front surface of the connector case 90. Also, first insertion openings 91 defined by the back walls 62 of the lower case 40 opening in a recessed shape and the back wall portions 76 of the upper case 70 are formed on the back surface of the connector case 90. Gaps are formed between the first terminals and the second terminals 20 disposed facing one another, with the gaps being narrower than the power storage pack side terminals 4 and the PCU side terminals 9 in terms of the thickness dimension. Also, at the positions corresponding to the hole portions 78 of the upper case 70, the second terminal side fastening holes 25 of the second terminals 20 and the first terminal side fastening holes 15 of the first terminals 11 are disposed overlapping the nut side fastening holes 34 of the nuts 33.

### Connecting the Power Storage Pack Side Terminals 4 and the PCU Side Terminals 9

The relay connector 10 described above is used as follows in the process of connecting the power storage pack side terminals 4 and the PCU side terminals 9.

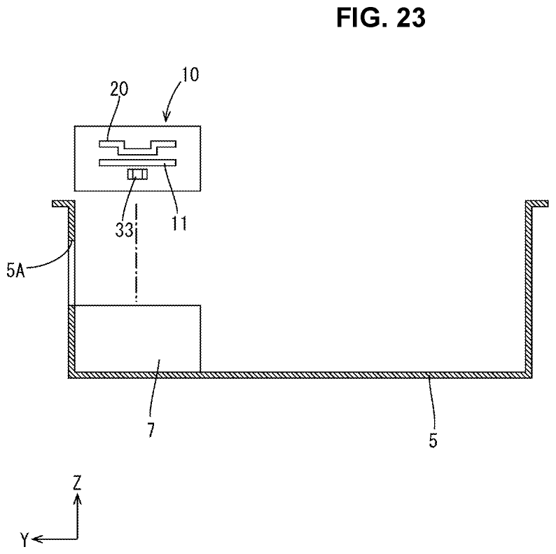

First, as illustrated in FIG. 23, the relay connector 10 is fixed at a predetermined position on the connector platform 7 installed inside the metal housing 5. Specifically, the relay connector 10 is fixed to the connector platform 7 by fastening the pair of attachment portions 54 provided on the connector case 90 (lower case 40) to the connector platform 7 with bolts. In this state, the relay connector 10 is disposed with the second insertion openings 92 overlapping the case side insertion openings 5A of the metal housing 5.

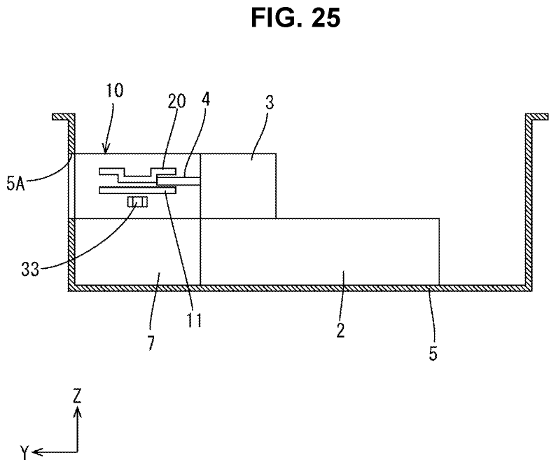

Next, as illustrated in FIG. 24, the power storage pack 2 with the junction box 3 installed on top is housed inside the metal housing 5 and moved forward, and the three tab-like power storage pack side terminals 4 projecting forward from the junction box 3 are inserted inside the relay connector 10 from the first insertion openings 91 (see FIG. 25).

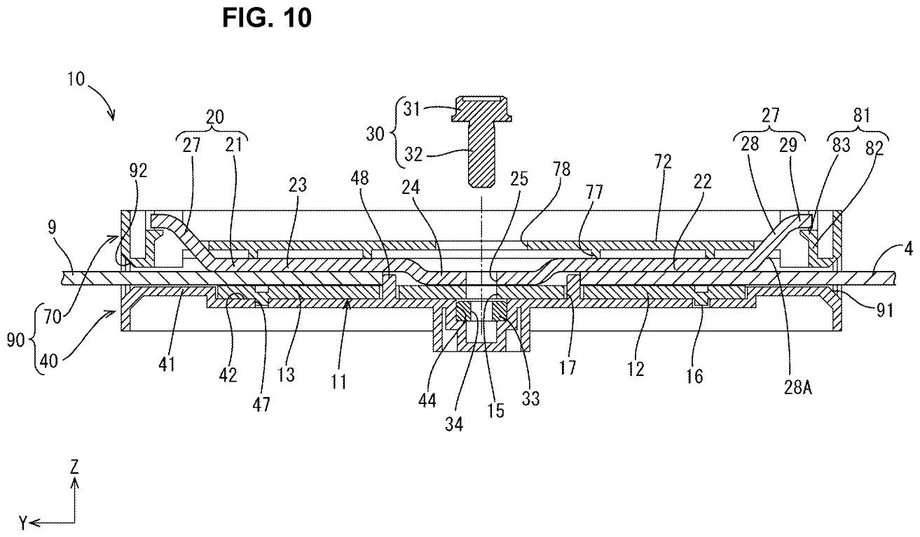

The power storage pack side terminals 4 inserted inside the relay connector 10 are, at the distal end portions, guided along the lower surfaces (guiding surfaces 28A) of the guide portions 28 of the second terminals 20 and easily inserted between the first connection portions 12 of the first terminals 11 and the first clamping portions 22 of the second terminals 20. At this time, in a case in which the gaps formed between the first connection portions 12 and the first clamping portions 22 due to the second terminals 20 being held in the upper case 70 and allowed to move in the up-and-down direction are slightly narrower than the thickness dimension of the power storage pack side terminals 4, the power storage pack side terminals 4 push up the second terminals 20 and easily enter between the first connection portions 12 and the first clamping portions 22. Also, even though the first clamping portions 22 of the second terminals 20 are pushed up, their own weight bring them back down to perfectly align and overlap with the power storage pack side terminals 4 (see FIGS. 10, 13, and 19).

Also, because the lower case side protrusion portions 48 project from the upper surfaces of the first terminals 11, the distal ends of the inserted power storage pack side terminals 4 come into contact with the lower case side protrusion portions 48, positioning the power storage pack side terminals 4 in the front-and-back direction (Y-direction).

Next, as illustrated in FIG. 26, the PCU 8 is orientated with the distal ends of the PCU side terminals 9 facing the metal housing 5 side and brought toward the metal housing 5 from the front surface side. As described above, the second insertion openings 92 of the relay connector 10 are exposed at the case side insertion opening 5A provided on the front surface of the metal housing 5. Thus, the PCU side terminals 9 are passed through the case side insertion opening 5A and inserted inside the connector case 90 from the second insertion openings 92 of the relay connector 10.

In this case also, in a similar manner to the power storage pack side terminals 4, the PCU side terminals 9 inserted inside the relay connector 10 are, at the distal end portions, guided along the lower surfaces (guiding surfaces 28A) of the guide portions 28 of the second terminals 20 and inserted between the second connection portions 13 of the first terminals 11 and the second clamping portions 23 of the second terminals 20. At this time, the second terminals 20 are held in the upper case 70 and allowed to move in the up-and-down direction. Thus, even in a case in which the gaps between the second connection portions 13 and the second clamping portions 23 are narrower than the thickness dimension of the PCU side terminals 9, the PCU side terminals 9 can push up the second terminals 20 and easily enter between the second connection portions 13 and the second clamping portions 23. Also, the second clamping portions 23 of the second terminals 20 are pushed up, and then their own weight brings them back down to align and overlap with the PCU side terminals 9.

Also, because the lower case side protrusion portions 48 project from the upper surfaces of the first terminals 11, the distal ends of the inserted PCU side terminals 9 come into contact with the lower case side protrusion portions 48, positioning the PCU side terminals 9 in the front-and-back direction (Y-direction) (see FIG. 10).

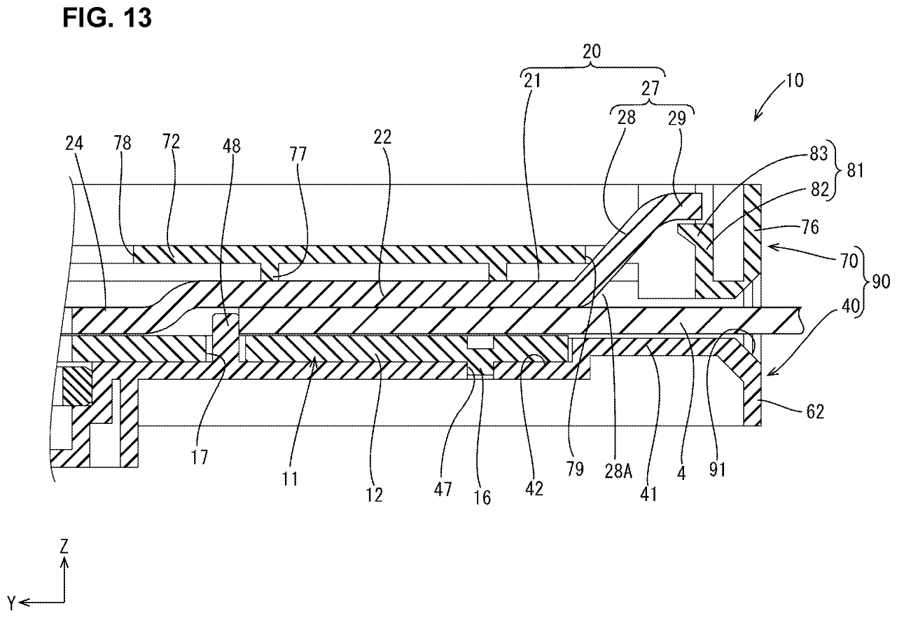

In this state, as described above, the second terminals 20 are slightly pushed up by the power storage pack side terminals 4 and the PCU side terminals 9, the upper surfaces of the first clamping portions 22 and the second clamping portions 23 of the second terminals 20 come into contact with the ribs 77 of the lower surface of the upper case 70, and the lower surfaces of the locking portions 29 of the second terminals 20 separate from the upper surfaces of the catch portions 83 of the flexible locking pieces 81 of the upper case 70 forming a gap between both (see FIG. 13).

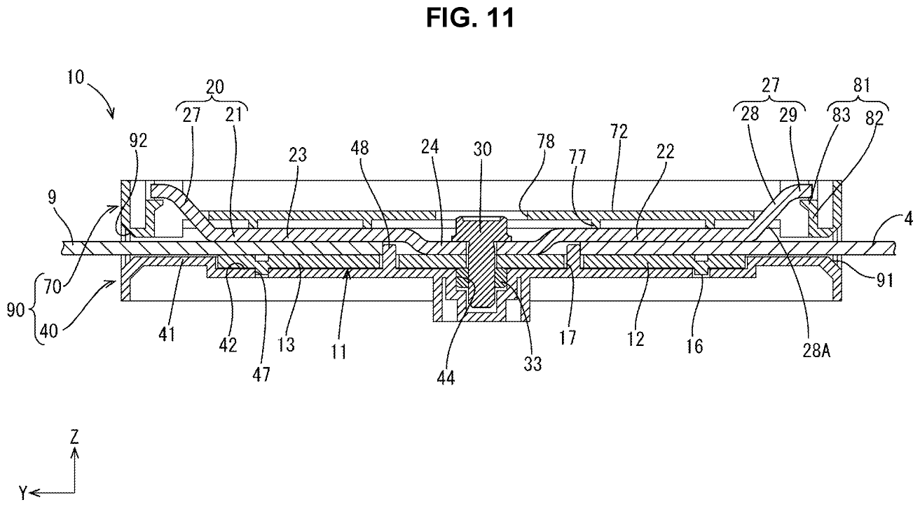

Next, the shaft portions 32 of the bolts 30 are inserted into the second terminal side fastening holes 25 exposed inside the hole portions 78 of the upper case 70, and the bolts 30 are fastened on the nuts 33 housed in the lower case 40. In this manner, the power storage pack side terminals 4 are firmly clamped between the first connection portions 12 of the first terminals 11 and the first clamping portions 22 of the second terminals 20, and the PCU side terminals 9 are firmly clamped between the second connection portions 13 of the first terminals 11 and the second clamping portions 23 of the second terminals 20. In other words, in this manner, the power storage pack 2 and the PCU 8 are conductively connected via the relay connector 10 (see FIGS. 11, 20, 22, and 28).

Regarding the terminals, the manufacturing tolerance in terms of the thickness dimension, warpage, case assembling tolerance, and the like may cause a gap to form between the first terminals 11 or the second terminals 20 and the power storage pack side terminals 4 or the PCU side terminals 9. Such a gap may cause a decrease in the conductive status.

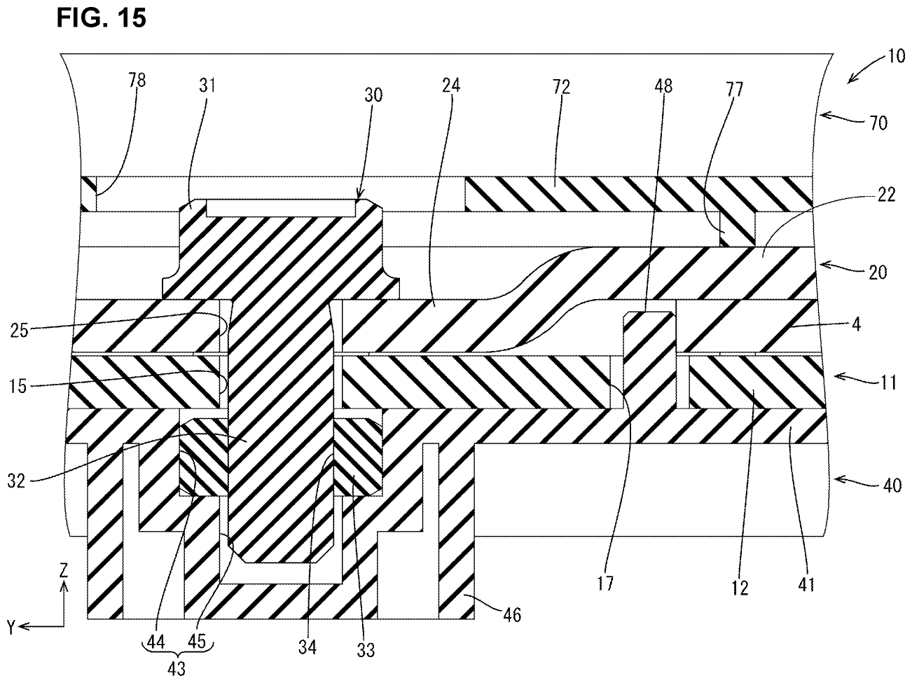

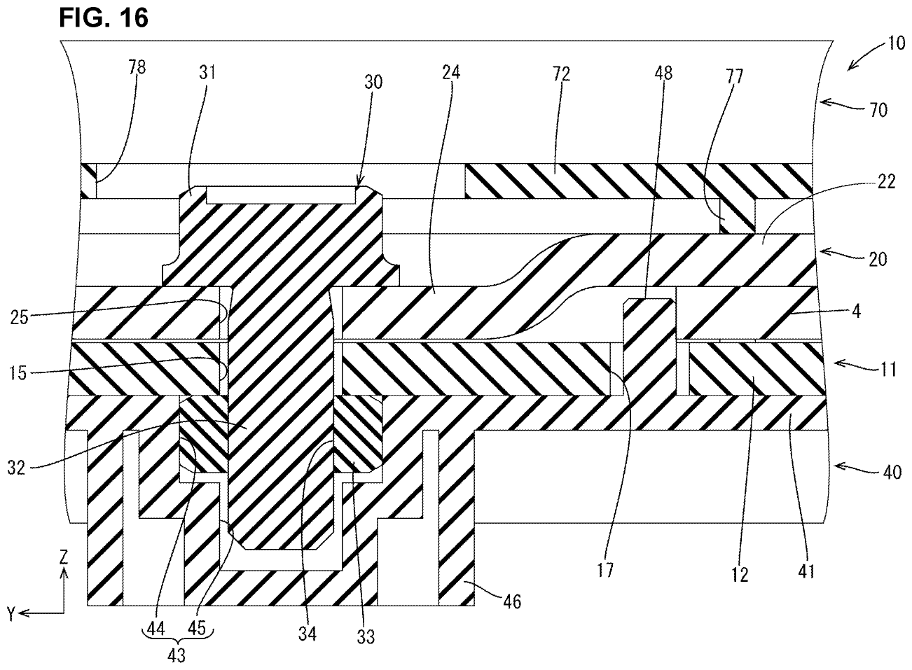

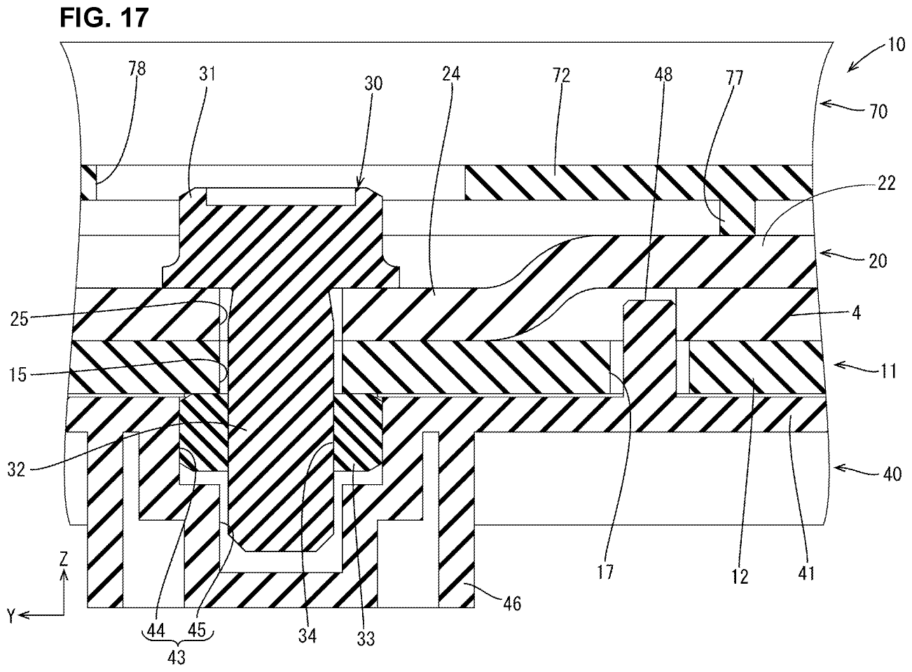

In light of this issue, the relay connector 10 of the present embodiment is provided with the following configuration in addition to the configuration in which the second terminals 20 are held in the upper case 70 in a state in which movement is allowed in the direction toward and the direction away (Z-direction in FIG. 11) from the upper case 70. When the bolts 30 are fastened into the nuts 33, as illustrated in FIG. 15, first, the shaft portions 32 of the bolts 30 are screwed into the nut side fastening holes 34 of the nuts 33 with the nuts 33 being housed in the lower ends of the nut housing portions 44. Then, as screwing progresses, the nuts 33 are gradually lifted up from the lower ends of the nut housing portions 44, and the upper surfaces of the nuts 33 come into contact with the lower surfaces of the first terminals 11 as illustrated in FIG. 16. If necessary, as screwing progresses further, the first terminals 11 are lifted up from the bottom walls 41 (positioning recess portions 42) by the nuts 33, fastening together the first terminals 11 and the second terminals 20 as illustrated in FIG. 17. In this manner, even in a case in which there are gaps between the first terminals 11 or the second terminals 20 and the power storage pack side terminals 4 or the PCU side terminals 9, the power storage pack side terminals 4 are clamped between the first connection portions 12 of the first terminals 11 and the first clamping portions 22 of the second terminals 20 and the PCU side terminals 9 are clamped between the second connection portions 13 of the first terminals 11 and the second clamping portions 23 of the second terminals 20, allowing the two to be brought into close contact.

In this manner, in the relay connector 10 of the present embodiment, not only are the second terminals 20 held in the upper case 70 and allowed to move in the up-and-down direction, but the first terminals 11 and the nuts 33 are held in the lower case 40 and allowed to move in the up-and-down direction. Thus, deformation (strain) of the terminals and stress on the terminals caused by tightening with the bolts 30 is not applied only to the second terminals 20 but can be dispersed to both the first terminals 11 and the second terminals 20, while also achieving a conductive connection between the terminals in a good state.

After the bolt fastening is complete, lastly, the metal cover 6 is mounted on the opening of the metal housing 5 as illustrated in FIG. 29.

### Advantageous Effects of Present Embodiment

According to the present embodiment, the following advantageous effects are achieved.

The relay connector 10 of the present embodiment is a connector that electrically connects the power storage pack side terminal 4 provided on the power storage pack 2 side and the PCU side terminal 9 provided on the PCU 8 side, the relay connector 10 including the first terminal 11 made of copper and including the first connection portion 12 configured to connect to the power storage pack side terminal 4 and the second connection portion 13 configured to connect to the PCU side terminal 9; the second terminal 20 disposed facing the first terminal 11 and including the first clamping portion 22 configured to clamp the power storage pack side terminal 4 together with the first connection portion 12 and the second clamping portion 23 configured to clamp the PCU side terminal 9 together with the second connection portion 13; and the connector case 90, wherein the connector case 90 includes a first insertion opening 91 for inserting the power storage pack side terminal 4 and the second insertion opening 92 for inserting the PCU side terminal 9; and the guide portions 28 are formed on the second terminal 20, the guide portions 28 guiding the power storage pack side terminal 4 inserted from the first insertion opening 91 between the first clamping portion 22 and the first terminal 11 and the PCU side terminal 9 inserted from the second insertion opening 92 between the second clamping portion 23 and the first terminal 11.

According to the configuration described above, to form an electrical connection, when the power storage pack side terminal 4 and the PCU side terminal 9 are inserted between the first terminal 11 and the second terminal 20, the distal end portions in the insertion direction of the power storage pack side terminal 4 and the PCU side terminal 9 are guided to a regular position by the guide portions 28 provided on the second terminal 20. Thus, a worker does not need to visually observe the terminals 4 and 9 when manually performing the positioning. For example, in cases in which the work space is narrow or the electrical wires connected to the terminals are difficult to manipulate, this allows for the connection work to be easily performed.

The guide portions 28 described above each include an inclined guiding surface 28A extending from the first clamping portion 22 or the second clamping portion 23 toward the first insertion opening 91 or the second insertion opening 92 at an incline in a direction (Z-direction) away from the first terminal 11. According to this configuration, the second terminal 20 can be easily provided with a guide portion with a simple configuration.

The connector case 90 is configured by assembling together the lower case 40 holding the first terminal 11 and the upper case 70 holding the second terminal 20. According to this configuration, the first terminal 11 and the second terminal 20 can be easily attached to the connector case 90.

The second terminal 20 is held in the upper case 70, the locking pieces 27 provided on the second terminal 20 are inserted into the locking piece insertion holes 79 provided on the upper case 70, and the first clamping portion 22 and the second clamping portion 23 are locked together with the flexible locking pieces 81 in a state in which movement is allowed in the direction toward and the direction away from the first terminal 11 (up-and-down direction, Z-direction).

According to the configuration described above, the dimension of the gap between the first terminal 11 and the second terminal 20 is set to be less than the thickness dimension of the power storage pack side terminal 4 and the PCU side terminal 9 in a state in which the terminals 4 and 9 are not inserted, and when the terminals 4 and 9 are inserted, the second terminal 20 is displaced in the direction away from the first terminal 11. Then, due to its own weight, the second terminal 20 comes into close contact with the inserted terminals 4 and 9.

Also, because the first terminal 11 and the second terminal 20 are both made of copper, the power storage pack side terminal 4 and the PCU side terminal 9 inserted into the relay connector 10 can be electrically connected via the first terminal 11 and the second terminal 20. In other words, the electrical connection state can be improved.

Also, the first terminal 11 and the second terminal 20 are fastened together via the bolt 30 and the nut 33. Thus, the power storage pack side terminal 4 and the PCU side terminal 9 inserted into the relay connector 10 can be clamped between the first terminal 11 and the second terminal 20 with a stronger force. In other words, the electrical connection state can be further improved.

### Second Embodiment

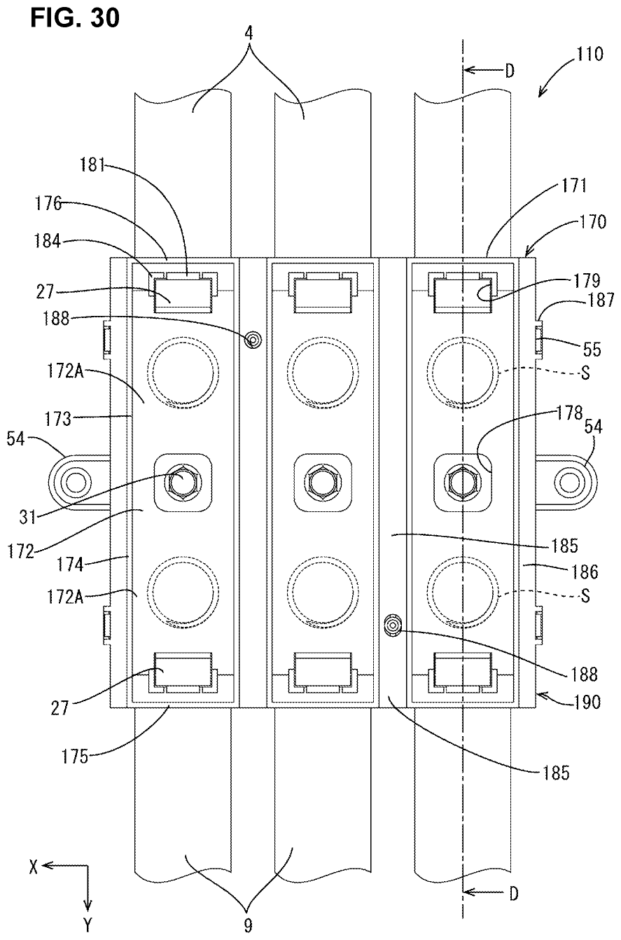

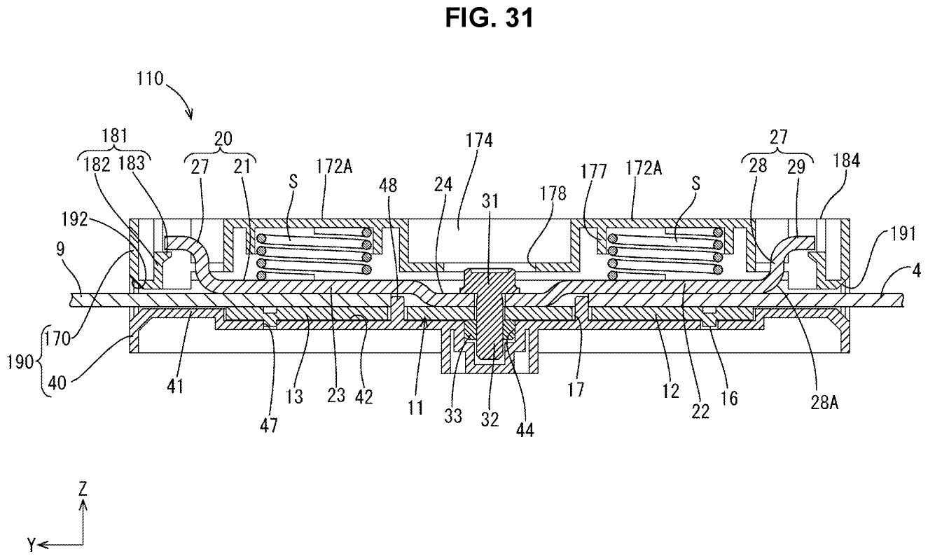

The second embodiment will now be described with reference to FIGS. 30 and 31. Hereinafter, members that are the same as those in the first embodiment will not be described and will be given the same reference numerals as in the first embodiment. Also, members that are not the same as in the first embodiment will be given a number equal to the reference numeral in the first embodiment plus 100, and only different portions will be described.

A relay connector 110 of the second embodiment is different from the relay connector 10 of the first embodiment described above in that, between a ceiling wall 172 of an upper case 170 and the first clamping portion 22 and the second clamping portion 23 of the second terminal 20, a compression coil spring S (an example of a biasing member) is disposed. The compression coil springs S are positioned in the front-and-back direction by a plurality of ribs 177 provided on the lower surface of the ceiling wall 172. For disposing the compression coil springs S, the portions of the ceiling wall 172 of the upper case 170 corresponding to the first clamping portion 22 and the second clamping portion 23 of the second terminal 20 are configured as spring housing portions 172A projecting upward in a box-like shape.

In this manner, according to a configuration in which the compression coil springs S, which urge the second terminal 20 toward the first terminal 11, are provided on the surface of the second terminal 20 on the opposite side to the first terminal 11, the power storage pack side terminal 4 and the PCU side terminal 9 inserted inside the relay connector 110 are pushed toward the first terminal 11 by the second terminal 20 with a strong force. This can further improve the electrical connection state.

Note that instead of the compression coil springs S, a plate spring or another type of spring member may be used, for example. In other words, it is only required that the member used can urge the second terminal 20 toward the first terminal 11.

### Third Embodiment

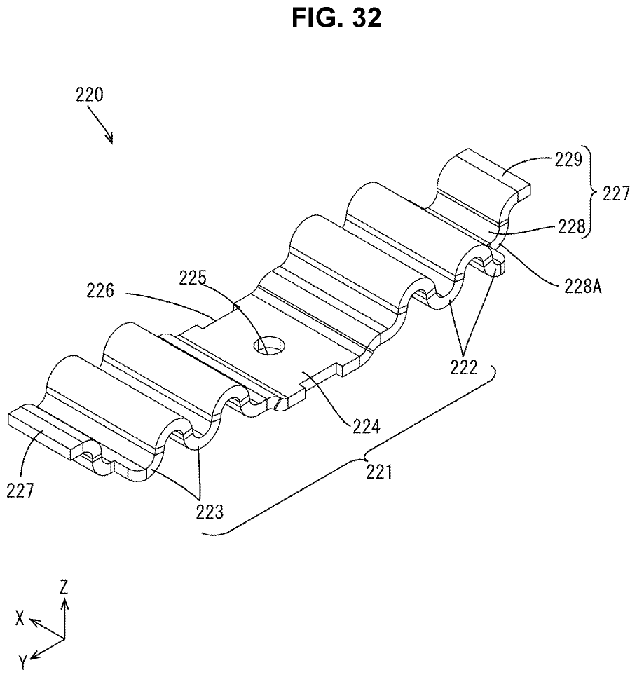

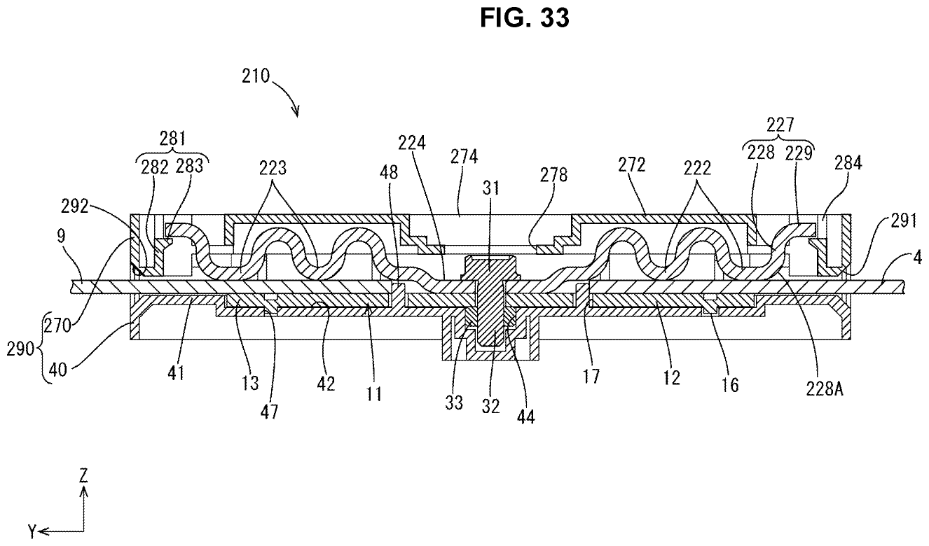

The third embodiment will now be described with reference to FIGS. 32 and 33. Hereinafter, members that are the same as those in the first embodiment will not be described and will be given the same reference numerals as in the first embodiment. Also, members that are not the same as in the first embodiment will be given a number equal to the reference numeral in the first embodiment plus 200, and only different portions will be described.

A relay connector 210 of the third embodiment is different from the first embodiment in that instead of the second terminal 20, a clamping plate 220 (an example of a clamping member) is used. The clamping plate 220 is made of stainless steel and is provided with a body portion 221 with a rectangular shape in a plan view and a pair of locking pieces 227 extending from both end edges in the longitudinal direction of the body portion 221.

A central portion in the longitudinal direction of the body portion 221 corresponds to a recess portion 224 which is recessed downward (toward the first terminal 11) across the entire width direction, and, in the central region of the recess portion 224, a second terminal side fastening hole 225 is provided extending through the plate surface. The shaft portion 32 of the bolt 30 is inserted into the second terminal side fastening hole 225 to fasten the clamping plate 220 to the first terminal 11. Also, a pair of cutout portions 226 are formed in the pair of side edge portions (edge portions in the Y-direction) of the recess portion 24. Terminal locking catches 56 of the lower case 40 are fit into the pair of cutout portions 226.

The end on one side (back side) in the longitudinal direction of the body portion 221 corresponds to a first clamping portion 222 for clamping the power storage pack side terminal 4 with the first connection portion 12 of the first terminal 11, and the end on the other side (front side) corresponds to a second clamping portion 223 for clamping the PCU side terminal 9 with the second connection portion 13 of the first terminal 11. The first clamping portion 222 and the second clamping portion 223 have a wave-like shape curving alternately up and down in a cross-section taken along the alignment direction of the first clamping portion 222 and the second clamping portion 223 (Y-direction). The lower ends of the first clamping portion 222 and the second clamping portion 223 with a wave-like shape come into contact with the upper surfaces of the power storage pack side terminal 4 and the PCU side terminal 9 and apply pressure.

According to this configuration also, the power storage pack side terminal 4 and the PCU side terminal 9 inserted inside the relay connector 210 are pushed toward the first terminal 11 by the elastic force of the wave-shaped clamping plate 220 with a strong force. This can further improve the electrical connection state.

Also, in this manner, because the clamping plate 220 is made of stainless steel which has high stiffness and resists deformation, the power storage pack side terminal 4 and the PCU side terminal 9 can be held clamped between the first terminal 11 and the clamping plate 220 by a strong force for an extended period of time.

### OTHER EMBODIMENTS

The present disclosure is not limited to the embodiments described above with reference to the drawings, and, for example, the following embodiments are also included in the technical scope.

1. In the embodiment described above, the back surface side of the locking pieces of the clamping member is used as a guide portion. However, the guide portion is not limited to this embodiment. For example, in another embodiment, the clamping member may be provided with ribs or grooves for guiding.

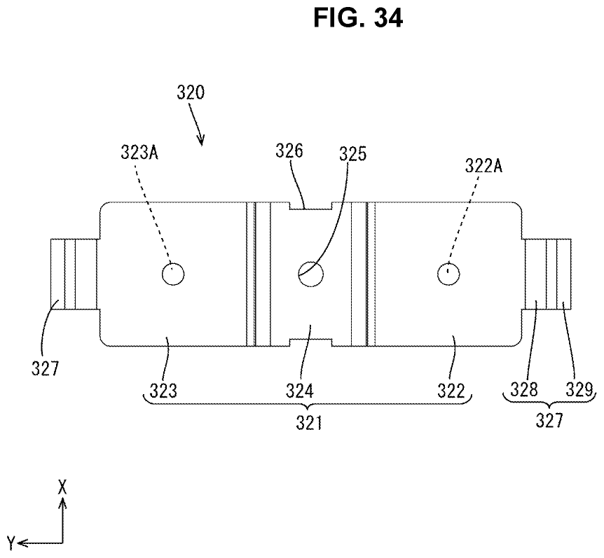

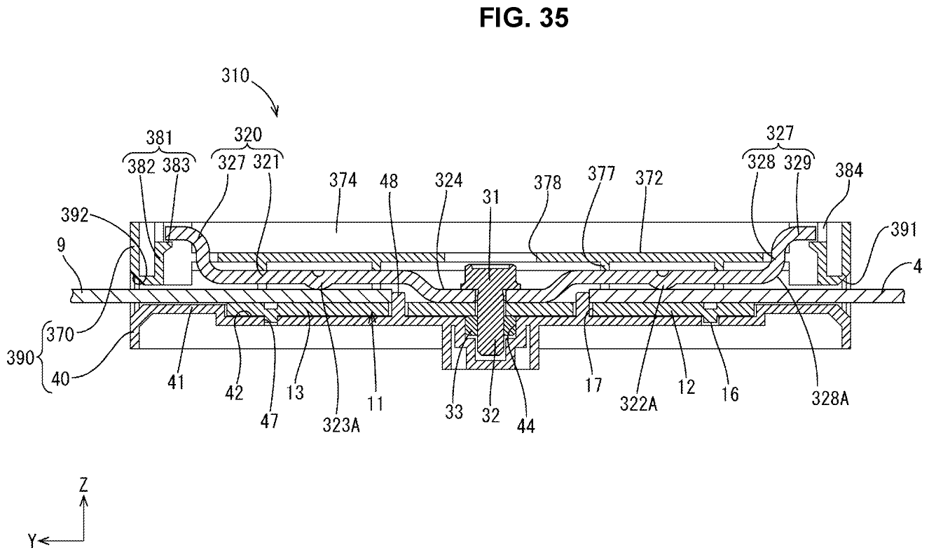

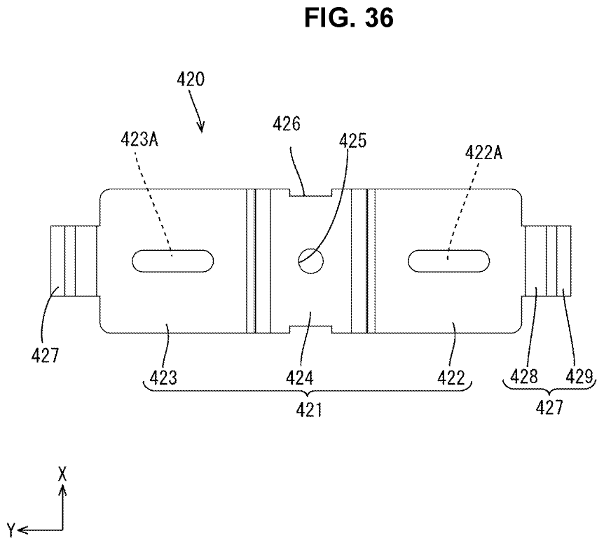

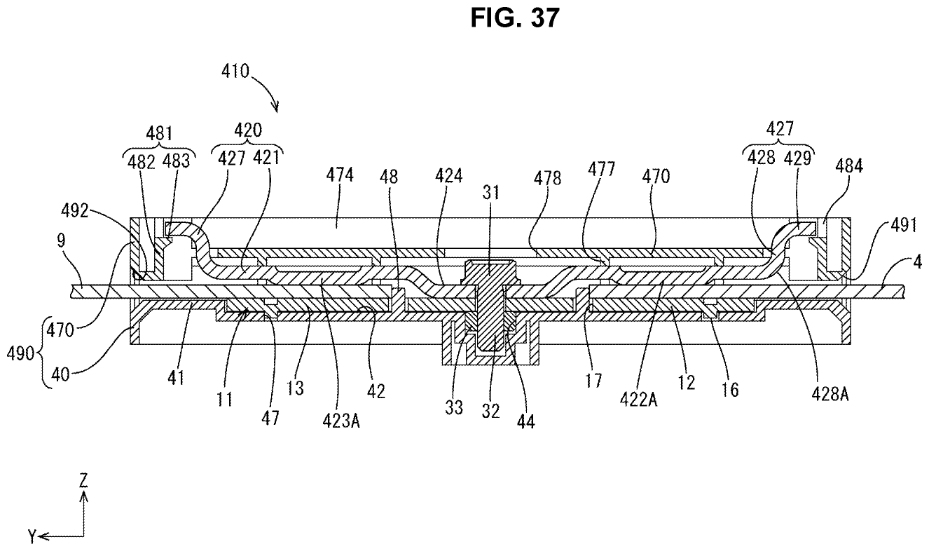

2. The configuration of the clamping member is not limited to the embodiment described above. For example, as illustrated in FIGS. 34 and 35, a configuration may be used in which protrusion portions 322A and 323A with a semicircular cross-sectional shape that projects toward the first terminal 11 are provided on a first clamping portion 322 and a second clamping portion 323 of a second terminal 320 (an example of a clamping member) with electrical conductivity, and the power storage pack side terminal 4 and the PCU side terminal are pressed by the protrusion portions 322A and 323A at spots. Also, as illustrated in FIGS. 36 and 37, a configuration may be used in which pressing ribs 422A and 423A with a rib-like shape that project toward the first terminal 11 and extend in the Y-direction are provided on a first clamping portion 422 and a second clamping portion 423 of a second terminal 420 (an example of a clamping member) with electrical conductivity.

Note that in the configurations illustrated in FIGS. 34 to 37, configurations that are the same as those in the first embodiment will not be described and will be given the same reference numerals as in the first embodiment. Also, members that are not the same as in the first embodiment will be given a number equal to the reference numeral in the first embodiment plus 300 or 400.

3. The structure for fixing the clamping member to the upper case is not limited to the embodiment described above and may be changed as appropriate. Preferably, the clamping member is fixed to the upper case in a state in which the first clamping portion and the second clamping portion of the clamping member are allowed to move in the direction toward and the direction away from the relay terminal. However, it is not necessary that movement is allowed, and the clamping member may be locked in the up in a fixed state.

4. Also, the structure for positioning the relay terminal in the lower case is not limited to the embodiment described above and may be changed as appropriate. For example, a configuration may be used in which the relay terminal is fixed to the lower case in a state in which movement is not allowed in the up-and-down direction.

5. In the embodiment described above, the relay terminal and the clamping member are fastened together via a fastening member. However, fastening via a fastening member is not required.

### LIST OF REFERENCE NUMERALS

1 Vehicle
2 Power storage pack
3 Junction box
4 Power storage pack side terminal (first device side terminal)
5 Metal housing
6 Metal cover
7 Connector platform
8 PCU
9 PCU side terminal (second device side terminal)
10, 110, 210, 310, 410 Relay connector
11 First terminal (relay terminal)
12 First connection portion
13 Second connection portion
15 First terminal side fastening hole
17 First terminal side hole portion
20, 320, 420 Second terminal (clamping member)
21, 221, 321, 421 Body portion
22, 222, 322, 422 First clamping portion
23, 223, 323, 423 Second clamping portion
24, 224, 324, 424 Recess portion
25, 225, 325, 425 Second terminal side fastening hole
26, 226, 326, 426 Cutout portion
27, 227, 327, 427 Locking piece (locking portion)
28, 228, 328, 428 Guide portion
28A, 228A, 328A, 428A Guiding surface (inclined surface)
29, 229, 329, 429 Locking portion
30 Bolt (fastening member)
31 Head portion
32 Shaft portion
33 Nut (fastening member)
34 Nut side fastening hole
40 Lower case
41 Bottom wall
42 Positioning recess portion
43 Housing recess portion
44 Nut housing portion
45 Relief portion
46 Protective wall
47 Lower case side hole portion
48 Lower case side protrusion portion
51 Partition wall
52 Lower case side positioning hole
53 Side wall
54 Attachment portion
55 Lower case side locking portion
56 Terminal locking catch
57 Elastically deforming portion
58 Catch portion
61 Front wall
62 Back wall
63 Recessed opening portion
64 Inclined surface
70, 170, 270, 370, 470 Upper case
71, 171, 271, 371, 471 Holding portion
72, 172, 272, 372, 472 Ceiling wall
73 Peripheral wall
74, 174, 274, 374, 474 Side wall portion
75 Front wall portion
76 Back wall portion
77, 177, 377, 477 Rib
78, 178, 278, 378 Hole portion
79, 179 Locking piece insertion hole (locked portion)
81, 181, 281, 381, 481 Flexible locking piece (locked portion)
82, 182, 282, 382, 482 Elastically deforming portion (locked portion)
83, 182, 282, 383, 482 Catch portion (locked portion)
84, 184, 284, 384, 484 Locking piece positioning portion
85 Connection wall
86 Auxiliary wall
87, 187 Upper case side locking piece
88, 188 Upper case side positioning hole
90, 190, 290, 390, 490 Connector case
91, 191, 291, 391, 491 First insertion opening
92, 192, 292, 392, 492 Second insertion opening
220 Clamping plate (clamping member)
322A Protrusion portion
422A Pressing rib
S Compression coil spring (biasing member)

1. A relay connector comprising:
a first device side terminal and a second device side terminal configured to be electrically connected;
a relay terminal with electrical conductivity including a first connection portion configured to connect to the first device side terminal and a second connection portion configured to connect to the second device side terminal;
a clamping member disposed facing the relay terminal and including a first clamping portion configured to clamp the first device side terminal together with the first connection portion and a second clamping portion configured to clamp the second device side terminal together with the second connection portion; and
a connector case, wherein
the connector case includes a first insertion opening for inserting the first device side terminal and a second insertion opening for inserting the second device side terminal; and
guide portions are formed on the clamping member, the guide portions configured to guide the first device side terminal inserted from the first insertion opening between the first clamping portion and the relay terminal, and the second device side terminal inserted from the second insertion opening between the second clamping portion and the relay terminal.

2. The relay connector according to claim 1, wherein
the guide portions are inclined surfaces inclined from the first clamping portion toward the first insertion opening and from the second clamping portion toward the second insertion opening, with an inclination direction of the inclined surfaces being a direction away from the relay terminal.

3. The relay connector according to claim 1, wherein
the connector case includes an assembly of a lower case configured to hold one from among the relay terminal and the clamping member and an upper case configured to hold the other from among the relay terminal and the clamping member.

4. The relay connector according to claim 3, wherein
the clamping member is held in the upper case; and
locking portions provided on the clamping member lock together with locked portions provided on the upper case, with the first clamping portion and the second clamping portion in a state in which movement is allowed in a direction toward and a direction away from the relay terminal.

5. The relay connector according to claim 1, wherein
a biasing member configured to urge the clamping member toward the relay terminal is provided on a surface of the clamping member on an opposite side to the relay terminal.

6. The relay connector according to claim 1, wherein
a cross-section of the clamping member taken along an alignment direction of the first clamping portion and the second clamping portion is a wave shape.

7. The relay connector according to claim 1, wherein
the clamping member includes an electrical conductive member.

8. The relay connector according to claim 1, wherein
the clamping member is made of stainless steel.

9. The relay connector according to claim 1, wherein
the relay terminal and the clamping member are fastened together via a fastening member.
